(19) United States
(12) Patent Application Publication
(10) Pub. No.: US 2017/0226316 A1
(43) Pub. Date: Aug. 10, 2017

(54) RESIN PARTICLE COMPOSITION

(71) Applicant: FUJI XEROX CO., LTD., Tokyo (JP)

(72) Inventors: Takeshi IWANAGA, Minamiashigara-shi (JP); Hiroyoshi OKUNO, Minamiashigara-shi (JP); Satoshi INOUE, Minamiashigara-shi (JP); Yoshifumi IIDA, Minamiashigara-shi (JP); Tomohito NAKAJIMA, Minamiashigara-shi (JP); Yuka ZENITANI, Minamiashigara-shi (JP); Yoshifumi ERI, Minamiashigara-shi (JP); Yasuo KADOKURA, Minamiashigara-shi (JP); Yasuhisa MOROOKA, Minamiashigara-shi (JP); Shunsuke NOZAKI, Tokyo (JP); Sakae TAKEUCHI, Minamiashigara-shi (JP)

(73) Assignee: FUJI XEROX CO., LTD., Tokyo (JP)

(21) Appl. No.: 15/223,575

(22) Filed: Jul. 29, 2016

(30) Foreign Application Priority Data
Feb. 10, 2016 (JP) 2016-024137
Feb. 10, 2016 (JP) 2016-024142

(51) Int. Cl. C08K 5/098; C08K 3/38; C08L 67/03; C08K 3/36

(52) U.S. Cl. CPC C08K 5/098; C08K 3/36; C08K 3/38; C08L 67/03; C08K 2201/003; C08K 2003/385; C08L 2203/18

(57) ABSTRACT

The invention is directed to a resin particle composition, containing: resin particles; lubricant particles; and silica particles having a compression aggregation degree of 60% to 95% and a particle compression ratio of 0.20 to 0.40, and a resin particle composition, containing: resin particles, on the surface of which at least a part of a release agent is exposed; and silica particles having a compression aggregation degree of 60% to 95% and a particle compression ratio of 0.20 to 0.40.

### CROSS-REFERENCE TO RELATED APPLICATIONS

This application is based on and claims priority under 35 USC 119 from Japanese Patent Application No. 2016-024137 filed on Feb. 10, 2016 and Japanese Patent Application No. 2016-024142 filed on Feb. 10, 2016.

### BACKGROUND

(i) Technical Field

The present invention relates to a resin particle composition.

(ii) Related Art

Resin particles have been applied to various applications such as a binder.

Here, in order to improve the strength and fluidity of resin particles and prevent the packing of resin particles, for example, silica particles may be used together with resin particles.

In particular, powder, such as resin particles, is often subjected to a transportation method (hereinafter, also referred to as “air transportation”) in which powder is transported by air flowing in a pipe. In the application of this transportation method, the improvement in fluidity of resin particles is important.

### SUMMARY

According to an aspect of the invention, there is provided a resin particle composition comprises: resin particles; lubricant particles; and silica particles having a compression aggregation degree of 60% to 95% and a particle compression ratio of 0.20 to 0.40.

### DETAILED DESCRIPTION

Hereinafter, exemplary embodiments of the present invention will be described.

Resin Particle Composition of First Embodiment of the Present Invention

The resin particle composition according to a first embodiment of the present embodiment includes: resin particles; lubricant particles; and silica particles having a compression aggregation degree of 60% to 95% and a particle compression ratio of 0.20 to 0.40 (hereinafter, referred to as “specific silica particles”).

It is known that a resin particle composition contains lubricant particles in addition to resin particles.

In the resin particle composition, the lubricity of the resin particle composition to the inner wall of a pipe is exhibited by the expression of lubricity due to lubricant particles at the time of transporting the resin particle composition using air, so as to prevent the fixation of the resin particle composition into a pipe.

Meanwhile, it is preferable that silica particles are used together with resin particles in order to impart fluidity to resin particles.

However, in the case of generally-used silica particles, in order to obtain sufficient fluidity of resin particles, these silica particles are required to be used in a large amount. As a result, the silica particles themselves are not easily treated because they are scattered, aggregates are formed by the silica particles detached from the resin particles, and the resin particles are not easily treated because they are scattered, thereby deteriorating the treatability of the resin particle composition.

Since the resin particle composition according to the first embodiment of the present embodiment is configured to include resin particles, lubricant particles, and specific silica particles, the fluidity of the resin particles and the treatability of the resin particle composition are excellent under high-temperature conditions (for example, at a temperature of 30° C.), and the fixation of the resin particle composition into a pipe at the time of transporting the resin particle composition by using air is prevented under the high-temperature conditions.

The reason for this is not clear, but it is considered to be due to the effects caused by the following characteristics of the specific silica particles.

Resin Particle Composition of Second Embodiment of the Present Invention

The resin particle composition according to a second embodiment of the present embodiment includes: resin particles, on the surface of which at least a part of a release agent is exposed (hereinafter, referred to as “release agent-containing resin particles, or simply “resin particles); and silica particles having a compression aggregation degree of 60% to 95% and a particle compression ratio of 0.20 to 0.40 (hereinafter, referred to as “specific silica particles”).

As the resin particles constituting the resin particle composition, release agent-containing resin particles.

The release agent-containing resin particles have a structure in which a part of the release agent is exposed to the surface of the resin particles. Due to the function of the exposed release agent, the releasing properties of the resin particle composition to the inner wall of a pipe are exhibited at the time of transporting the resin particle composition by using air, thereby preventing the fixation of the resin particle composition into a pipe.

Meanwhile, in the resin particles, on the surface of which at least a part of the release agent is exposed, the resin particles are easily aggregated by the adhesiveness of the release agent, thereby deteriorating the fluidity of the resin particles.

Further, in order to impart fluidity to the release agent-containing resin particles, a fluidizer, such as silica particles, is used.

However, in the case of silica particles generally used as a fluidizer, such silica particles are easily adhered to the exposed portion of the release agent by the adhesiveness of the release agent, maintained, and unevenly distributed therein. As a result, the generally-used silica particles inhibit the expression of releasing properties caused by the release agent, and thus it is difficult to prevent the fixation of the resin particle composition into a pipe at the time of transporting the resin particle composition by using air. Further, the fluidity of the resin particles also tends to be deteriorated by the uneven distribution of the generally-used silica particles on the surface of the resin particles.

Further, in order to obtain sufficient fluidity of the release agent-containing resin particles, a method of using the generally-used silica particles in a large amount is considered. However, in this case, the silica particles themselves are not easily treated because they are scattered, aggregates are formed by the silica particles ditched from the resin particles, and the resin particles are not easily treated because they are scattered, thereby deteriorating the treatability of the resin particle composition.

Particularly, in the case where the shape of the resin particles is irregular, the generally-used silica particles are difficult to adhere to the projection portion of the resin particles, and thus the uneven distribution of the generally-used silica particles on the surface of the resin particles becomes more serious. In order to increase the fluidity of the resin particles by adhering the silica particles up to the projection portion of the resin particles, it is required to use the silica particles in a large amount. As a result, it is considered that the deterioration in treatability of the resin particle composition is easily caused as described.

From the above, in the case where the shape of the resin particles is irregular, particularly, it is desired to increase the fluidity of the resin particles and prevent the deterioration in treatability of the resin particle composition.

Since the resin particle composition according to the second embodiment of the present embodiment is configured to include resin particles, on the surface of which at least a part of a release agent is exposed (hereinafter, referred to as “release agent-containing resin particles), and specific silica particles, the fluidity of the resin particles and the treatability of the resin particle composition are excellent, and the fixation of the resin particle composition into a pipe at the time of transporting the resin particle composition by using air is prevented.

The reason for this is not clear, but it is considered to be due to the effects caused by the following characteristics of the specific silica particles.

Specific Silica Particles Of The Present Invention

It is considered that, when the compression aggregation degree and particle compression ratio of the specific silica particles are within the above ranges, respectively, the specific silica particles of the first and second embodiments of the present invention exhibit the following effects.

First, the significance of setting the compression aggregation degree of the specific silica particles to 60% to 95% will be described.

The compression aggregation degree is an index indicating the aggregability of silica particles and the adhesiveness of silica particles to resin particles. This index is indicated by the degree of unraveling difficulty of a compact obtained by compressing silica particles when dropping the compact of silica particles.

Thus, as the compression aggregation degree increases, the aggregation force (intermolecular force) of silica particles tends to become stronger, and the adhesion force of silica particles to resin particles also tends to be stronger. The details of the method of calculating the compression aggregation degree will be described later.

Therefore, the specific silica particles, the compression aggregation degree of which is highly controlled in a range of 60% to 95%, have good aggregability and good adhesiveness to resin particles. However, from the viewpoint of securing the fluidity of silica particles and the dispersibility of silica particles to resin particles while maintaining good aggregability of silica particles and good adhesiveness of silica particles to toner particles, the upper limit value of the compression aggregation degree is set to 95%.

Next, the significance of setting the particle compression ratio of the specific silica particles to 0.20 to 0.40 will be described.

The particle compression ratio is an index indicating the fluidity of silica particles. Specifically, the particle compression ratio is indicated by the ratio of difference between compressed apparent specific gravity and loose apparent specific gravity of silica particles to compressed apparent specific gravity of silica particles ((compressed apparent specific gravity-loose apparent specific gravity)/compressed apparent specific gravity).

Thus, as the particle compression ratio decreases, the fluidity of silica particles increases. Further, as the fluidity of silica particles increases, the dispersibility of silica particles to resin particles tends to become high. The details of the method of calculating the particle compression ratio will be described later.

Therefore, the specific silica particles, the particle compression ratio of which is lowly controlled in a range of 0.20 to 0.40, have good fluidity and good dispersibility to resin particles. However, from the viewpoint of improving the aggregability of silica particles and the adhesiveness of silica particles to resin particles while maintaining good fluidity of silica particles and good dispersibility of silica particles to resin particles, the lower limit value of the particle compression ratio is set to 0.20.

From the above, the specific silica particles are characterized in that they are easily fluidized, they are easily dispersed in resin particles, and they have high aggregation force and high adhesion force to resin particles.

Accordingly, the specific silica particles, the compression aggregation degree and particle compression ratio of which satisfy the above range, are silica particles having properties of high fluidity, high dispersibility to resin particles, high aggregability, and high adhesiveness to resin particles.

Next, in the first embodiment of the present invention, estimated effects at the time of using specific silica particles in the resin particle composition including resin particles and lubricant particles will be described.

First, since the specific silica particles have high fluidity and high dispersibility to resin particles, they are easily adhered to the surface of resin particles in an almost uniform state when they are mixed with resin particles. Meanwhile, since the specific silica particles adhered to the surface of the resin particles once have high adhesiveness to the resin particles, it is difficult to cause the movement on the resin particles and the liberation from the resin particles. In particular, it is considered that the specific silica particles adhered to the surface of the resin particles once is difficult to cause the movement on the resin particles and the liberation from the resin particles at a load attributable to the air flow occurring when transporting the resin particle composition using air.

As described above, the specific silica particles are easily adhered to the surface of the resin particles in an almost uniform state, and this adhesion state is easily maintained. It is considered that, with the adhesion state of these specific particles, the lubricant particles also are difficult to be unevenly distributed on the surface of the resin particles, and thus the lubricant particles are easily adhered to the surface of the resin particles in an almost uniform state.

As a result, it is considered that the lubricity of the resin particle composition to the inner wall of the pipe is more efficiently exhibited by the lubricant particles, thereby preventing the fixation of the resin particle composition into a pipe.

In the resin particle composition including resin particles and lubricant particles, it is difficult to obtain sufficient fluidity of the resin particles.

The specific silica particles, as described above, are characterized in that they are easily adhered to the surface of the resin particles in an almost uniform state, and this adhesion state is easily maintained, and in that they are particles that can increase the fluidity of specific particles duet to the materials. Therefore, when the specific silica particles are used in the resin particle composition including resin particles and lubricant particles, it is considered that the specific silica particles are efficiently adhered to the surface of the resin particles without using the specific silica particles in a large amount, thereby increasing the fluidity of the resin particles.

Further, the specific silica particles, as described above, have high aggregability. Therefore, when the specific silica particles are used in the resin particle composition including resin particles and lubricant particles, it is considered that, due to the aggregability of the specific silica particles, the specific silica particles themselves detached from the resin particles are scattered, aggregates of the specific silica particles detached from the resin particles are formed, and it is easy to prevent the resin particles from being scattered. Accordingly, the resin particle composition according to the first embodiment of the present invention is excellent even in treatability (referred to as handling properties).

Next, in the second embodiment of the present invention, estimated effects at the time of using release agent-containing resin particles and specific silica particles will be described.

First, since the specific silica particles have high fluidity and high dispersibility to resin particles, they are easily adhered to the surface of resin particles in an almost uniform state when they are mixed with resin particles. Further, since the specific silica particles adhered to the surface of the resin particles once have high adhesiveness to the resin particles, it is difficult to cause the movement on the resin particles and the liberation from the resin particles. In particular, it is considered that the specific silica particles adhered to the surface of the resin particles once is difficult to cause the movement on the resin particles and the liberation from the resin particles at a load attributable to the air flow occurring when transporting the resin particle composition using air.

Meanwhile, the release agent-containing resin particles have a structure in which at least a part of the release agent is exposed to the surface of the resin particles. The surface of the resin particles are formed such that the exposed portion of the release agent and the surface due to resin exist in a mixed state. Even for the resin particles having such a surface state, since the silica particles are excellent in fluidity and dispersibility to the resin particles, the silica particles are easily adhered to the surface of the resin particles in an almost uniform state, and this adhesion state is easily maintained.

Therefore, according to the resin particle composition of the second embodiment of the present invention, the fluidity of the release agent-containing resin particles is increased, and the function of the release agent contained in the resin particles is difficult to be inhibited by the specific silica particles, thereby preventing the fixation of the resin particle composition into a pipe at the time of transporting the resin particle composition by using air.

The adhesion state of these specific silica particles is easily maintained even when the resin particles are irregular, because the specific silica particles have excellent fluidity and dispersibility to the resin particles. That is, it is considered that the specific silica particles can be adhered even to the projection portion of irregular resin particles in an almost uniform state without using the specific silica particles in a large amount.

In other words, in the resin particle composition according to the second embodiment of the present invention, the fluidity of the resin particles is increased without using the specific silica particles in a large amount, and, as a result, the deterioration in treatability of the resin particle composition, caused by using the specific silica particles in a large amount, can be prevented.

Further, the specific silica particles, as described above, have high aggregability. Therefore, when the specific silica particles are used in the resin particle composition including the release agent-containing resin particles, it is considered that, due to the expression of hig aggregability of the specific silica particles, the specific silica particles themselves detached from the resin particles are scattered, aggregates of the specific silica particles detached from the resin particles are formed, and it is easy to prevent the resin particles from being scattered. From this point of view, it is considered that the resin particle composition according to the second embodiment of the present invention is excellent even in treatability (referred to as handling properties).

In each of the resin particle compositions according to the first and second exemplary embodiments, it is preferable that the particle dispersion degree of the specific silica particles is 90% to 100%.

Here, the significance of setting the particle dispersion degree of the specific silica particles to 90% to 100% will be described.

The particle dispersion degree is an index indicating the dispersibility of silica particles. This index is indicated by the degree of easiness of dispersion of silica particles to resin particles in the primary particle state. Specifically, the particle dispersion degree is indicated by the ratio of actually-measured coverage C to calculated coverage C₀ (actually-measured coverage C/calculated coverage C₀) when the calculated coverage of resin particles with silica particles is represented by C₀ and the actually-measured coverage thereof is represented by C.

Therefore, as the particle dispersion degree increases, silica particles are difficult to aggregate, and are easy to be dispersed to the resin particles in the primary particle state. The details of the method of calculating the particle dispersion degree will be described later.

The dispersibility of the specific silica particles to the resin particles is further improved by controlling the particle dispersion degree to 90% to 100% at a high level while controlling the compression aggregation degree and the particle compression ratio within the above range.

Thus, the lubricant particles in the resin particle composition of the first embodiment of the present invention are easily adhered to the surface of the resin particles in an almost uniform state. As a result, the resin particle composition of the first embodiment of the present invention exhibits high lubrication function in the pipe, thereby easily preventing the fixation of the resin particle composition into a pipe in the case of transporting the resin particle composition using air.

Accordingly, the specific silica particles are easily adhered to the surface of the release agent-containing resin particles of the second embodiment of the present invention in an almost uniform state. As a result, in the resin particles composition according to the second embodiment of the present invention, the releasing properties of the release agent contained in the resin particles are more efficiently exhibited, so that the fixation of the resin particle composition into a pipe is easily prevented, and the fluidity of the resin particles and the treatability of the resin particle composition are further improved.

In each of the resin particle compositions according to the first and second exemplary embodiments, as described above, as the specific silica particles, which have properties of high fluidity and high dispersibility to resin particles, high aggregability, and high adhesiveness to resin particles, silica particles, the surfaces of which are coated with a siloxane compound having a relatively large weight average molecular weight, are preferably exemplified. Specifically, silica particles, the surfaces of which are coated with a siloxane compound having a viscosity of 1,000 cSt to 50,000 cSt, are preferably exemplified. These specific silica particles are obtained by a surface treatment method in which the surfaces of silica particles are treated with a siloxane compound having a viscosity of 1,000 cSt to 50,000 cSt such that the surface coated amount is 0.01% by weight to 5% by weight.

Here, the surface coated amount is referred to as the weight ratio of the siloxane compound with which the surface of the silica particle is coated to the silica particle whose surface is not coated with the siloxane compound (untreated silica particle).

Hereinafter, the silica particles whose surfaces are not coated with the siloxane compound (that is, untreated silica particles) are simply referred to as “silica particles”.

The specific silica particles, to the surfaces of which a siloxane compound having a viscosity of 1,000 cSt to 50,000 cSt is adhered such that the surface coated amount of the siloxaine compound is 0.01% by weight to 5% by weight, have high aggregability and high adhesiveness to resin particles as well as high fluidity and high dispersibility to resin particles, and the compression aggregation degree and particle compression ratio thereof easily satisfy the above requirements.

The reason for this is not clear, but it is considered to be due to the following reasons.

When the siloxane compound having relatively high viscosity within the above range adheres to the surface of silica particles in a small amount within the above range, the function derived from the properties of the siloxane compound on the surface of the silica particles is expressed. Although the mechanism is not clear, when the specific silica particles are fluidized, the releasing properties derived from the siloxane compound are easily expressed by adhering a small amount of the siloxane compound having relatively high viscosity to the surface thereof within the above range, or the adhesiveness (aggregability) between the silica particles is deteriorated by the reduction of the inter-particle force due to the steric hindrance of the siloxane compound. Thus, the fluidity of silica particles and the dispersibility of silica particles to resin particles increase.

Meanwhile, when the silica particles are compressed, the long molecular chains of the siloxane compound of the surface of the silica particles are entangled, so that the closest packing properties of the silica particles increase, and the aggregation force between the silica particles is intensified. Further, it is considered that the aggregation force of the silica particles due to the entanglement of the long molecular chains of this siloxane compound is released by fluidizing the silica particles. In addition to this, the adhesion force of the silica particles to resin particles is also increased by the long molecular chains of the siloxane compound of the surface of the silica particles.

From the above, in the specific silica particles, in which the siloxane compound having viscosity within the above range adheres to the surface of silica particles in a small amount within the above range, the compression aggregation degree and particle compression ratio thereof easily satisfy the above requirements, and the particle dispersion degree thereof also easily satisfy the above requirements.

Hereinafter, the configuration of the resin particle composition will be described.

First, the specific silica particles will be described.

Specific Silica Particles

The specific silica particles have a compression aggregation degree of 60% to 95% and a particle compression ratio of 0.20 to 0.40.

First, the characteristics of silica particles will be described in detail.

Compression Aggregation Degree

The compression aggregation degree of the specific silica particles, from the viewpoint of securing the fluidity of the specific silica particles and the dispersibility of the specific silica particles to resin particles while maintaining good aggregability of the specific silica particles and good adhesiveness of the specific silica particles to resin particles, is 60% to 95%, preferably 65% to 95%, and more preferably 70% to 95%.

The compression aggregation degree is calculated by the following method.

A disc-shaped mold having a diameter of 6 cm is filled with 6.0 g of the specific silica particles. Next, the mold is compressed for 60 seconds by a pressure of 5.0 t/cm² using a compression molding machine (manufactured by Maekawa Testing Machine MFG Co., Ltd.), so as to obtain a compressed disc-shaped compact of the specific silica particles (hereinafter, referred to as “compact before falling”). Thereafter, the weight of the compact before falling is measured.

Next, the compact before falling is placed on a sieve screen having a mesh opening of 600 μm, and is fallen by a vibration sieve machine (part number: VIBRATING MVB-1, manufactured by TSUTSUI SCIENTIFIC INSTRUMENTS CO., LTD.) under the conditions of amplitude of 1 mm and vibration time for 1 minute. Thus, the specific silica particles are fallen from the compact before falling through the sieve screen, and the compact of the specific silica particles remains on the sieve screen. Thereafter, the weight of the remaining compact of the specific silica particles (hereinafter, referred to as “compact after falling”) is measured.

Then, the compression aggregation degree is calculated from the ratio of weight of compact after falling to weight of compact before falling, using Equation (1) below.

compression aggregation degree=(weight of compact after falling/weight of compact before falling)×100 Equation (1):

Particle Compression Ratio

The particle compression ratio of the specific silica particles, from the viewpoint of securing the aggregability of the specific silica particles and the dispersibility of the specific silica particles to resin particles while maintaining good fluidity of the specific silica particles and good adhesiveness of the specific silica particles into resin particles (particularly, from the viewpoint of preventing the fixation of the resin particle composition into a pipe when transporting the resin particle composition using air), is 0.20 to 0.40, preferably 0.28 to 0.38, and more preferably 0.28 to 0.36.

The particle compression ratio is calculated by the following method.

The compressed apparent specific gravity and loose apparent specific gravity of silica particles are measured using a powder tester (manufactured by Hosokawa Micron Corporation, part number PT-S type).

Then, the particle compression ratio is calculated from the ratio of difference between compressed apparent specific gravity and loose apparent specific gravity of silica particles to compressed apparent specific gravity, using Equation (2) below.

particle compression ratio=(compressed apparent specific gravity-loose apparent specific gravity)/compressed apparent specific gravity Equation (2):

Here, the “loose apparent specific gravity” is a measurement value derived by filling a container having a volume of 100 cm³ with silica particles and weighing the container filled with the silica particles, and refers to filling specific gravity in a state of the specific silica particles being naturally fallen into the container. The “compressed apparent specific gravity” refers to apparent specific gravity of the specific silica particles which are deaerated, rearranged and more densely packed by repeatedly applying an impact to the bottom of the container (tapping the bottom of the container) at a stroke length of 18 mm and a tapping speed of 50 times/min 180 times from the state of loose apparent specific gravity.

Particle Dispersion Degree

The particle dispersion degree of the specific silica particles, from the viewpoint of further improving the dispersibility of the specific silica particles to resin particles, is preferably 90% to 100%, more preferably 95% to 100%, further more preferably 100%.

The particle dispersion degree refers to the ratio of actually-measured coverage C of resin particles with the specific silica particles to calculated coverage C₀, and is calculated using Equation (3) below.

particle dispersion degree=actually-measured coverage C/calculated coverage C₀ Equation (3):

Here, the calculated coverage C₀ of the surface of resin particles with the specific silica particles may be calculated using Equation (3-1) below, when the volume average particle diameter of resin particles is represented by dt (m), the average circle-equivalent diameter of the specific silica particles is represented by da (m), the specific gravity of resin particles is represented by ρt, the specific gravity of the specific silica particles is represented by ρa, the weight of resin particles is represented by Wt (kg), and the addition amount of the specific silica particles is represented by Wa (kg).

calculated coverage C₀=√3/(2π)×(ρt/ρa)×(dt/da)×(Wa/Wt)×100 (%) Equation (3-1):

The actually-measured coverage C of the surface of resin particles with the specific silica particles can be calculated using Equation (3-2) below, after the signal intensities of silicon atoms derived from the specific silica particles are measured with respect to only the resin particles, only the specific particles, and the resin particles including the specific silica particles, respectively, by an X-ray photoelectron spectroscopy (XPS) (“JPS-9000MX”, manufactured by JEOL Ltd.).

actually-measured coverage C=(z−x)/(y−x)×100(%) Equation (3-2):

(in Equation (3-2), x represents signal intensity of silicon atoms derived from the specific silica particles with respect to only the resin particles. y represents signal intensity of silicon atoms derived from the specific silica particles with respect to only the specific silica particles. z represents signal intensity of silicon atoms derived from the specific silica particles with respect to the resin particles coated (covered) with the specific silica particles.)

Average Circle-equivalent Diameter

The average circle-equivalent diameter of the specific silica particles can be appropriately determined depending on the particle diameter of resin particles, but, from the viewpoint of improving fluidity, dispersibility to resin particles, aggregability, and adhesiveness to resin particles, is preferably 40 nm to 200 nm, more preferably 50 nm to 180 nm, and further more preferably 60 nm to 160 nm.

The average circle-equivalent diameter D50 of the specific silica particles are obtained as follows. Primary particles after dispersing the specific silica particles into resin particles are observed by a scanning electron microscope (SEM) (S-4100, manufactured by Hitachi, Ltd.) to capture an image, this image is put into an image analyzer (LUZEX III, manufactured by Nireco Corporation), the area of each particle is measured by the image analysis of the primary particles, and the circle-equivalent diameter of the particle is calculated from this area value. The 50% diameter (D50) in the volume-based cumulative frequency of the obtained circle-equivalent diameter is set to the average circle-equivalent diameter D50 of the specific silica particles. In addition, the magnification of the electron microscope is adjusted such that 10 to 50 specific silica particles appear in one field of view, and the circle-equivalent diameter of the primary particle is obtained in combination with observations in multiple fields of view.

Average Circularity Degree

Although the shape of the specific silica particles may be any of a spherical shape and different shapes, the average circularity degree of the specific silica particles, from the viewpoint of improving fluidity, dispersibility to resin particles, aggregability, and adhesiveness to resin particles in the specific silica particles, is preferably 0.85 to 0.98, more preferably 0.90 to 0.98, and further more preferably 0.93 to 0.98.

The average circularity degree of the specific silica particles is measured by the following method.

First, the circularity degree of the specific silica particles is obtained as “100/SF2” calculated by the following equation (4), from the analysis of the planar image obtained by observing the primary particles after adhering silica particles to the surface of resin particles by SEM.

circularity degree (100/SF2)=47π×(A/I²) Equation (4):

(In the equation (4), I represents a boundary length of primary particles in an image, and A represents a projected area of primary particles.)

Further, the average circularity degree of the specific silica particles is obtained as 50% circularity degree in the cumulative frequency of circularity degree of 100 primary particles obtained by the above planar image analysis.

Here, a method of measuring the characteristics (compression aggregation degree, particle compression ratio, particle dispersion degree, and average circularity degree) of the specific silica particles in the resin particle composition will be described.

First, resin particles, lubricant particles, and specific silica particles are separated from the resin particle composition of the first embodiment of the present invention as follows, and release agent-containing resin particles and specific silica particles are separated from the resin particle composition of the second embodiment of the present invention as follows.

That is, the resin particle composition is dispersed in methanol, stirred, and then ultrasonically treated with an ultrasonic bath, so as to strip the specific silica particles having a large diameter from the surface of the resin particle composition. Thereafter, The resin particle composition is precipitated by centrifugation to collect only the methanol dispersed with the specific silica particles, and then this methanol is volatilized, so as to extract the specific silica particles.

Then, the above characteristics are measured using the separated specific silica particles.

Next, the configuration of the specific silica particles will be described.

Silica Particles

The specific silica particles, which are particles containing silica (that is, SiO₂) as a main component, may be crystalline particles or irregular particles. The specific silica particles may be particles prepared using a silicon compound, such as water glass or alkoxysilane, as a raw material, and may also be particles obtained by pulverizing quartz.

Examples of the specific silica particles include silica particles fabricated by a sol-gel process (hereinafter, referred to as “sol-gel silica particles”), aqueous colloidal silica particles, alcoholic silica particles, fumed silica particles obtained by a gas-phase process, and molten silica particles. Among these silica particles, sol-gel silica particles are preferable.

It is preferable that the specific silica particles having the compression aggregation degree, particle compression ratio and particle dispersion degree within the above specific range are specific silica particles, to the surface of which a siloxane compound is adhered.

In order to obtain specific silica particles, to the surface of which the siloxane compound is adhered, it is preferable to use surface treatment with the siloxane compound, and it is particularly preferable to perform the surface treatment to the surface of the silica particles in supercritical carbon dioxide using the supercritical carbon dioxide. The surface treatment method will be described later.

Siloxane Compound

The siloxane compound is not particularly limited as long as it has a siloxane skeleton in a molecular structure.

Examples of the siloxane compound include silicone oil and silicone resin. Among these, silicone oil is preferable, from the viewpoint of surface-treating the surface of silica particles in an almost uniform state.

Examples of silicone oil include dimethyl silicone oil, methyl hydrogen silicone oil, methylphenyl silicone oil, amino-modified silicone oil, epoxy-modified silicone oil, carboxyl-modified silicone oil, carbinol-modified silicone oil, methacryl-modified silicone oil, mercapto-modified silicone oil, phenol-modified silicone oil, polyether-modified silicone oil, methylstyryl-modified silicone oil, alkyl-modified silicone oil, higher fatty acid ester-modified silicone oil, higher fatty acid amide-modified silicone oil, and fluorine-modified silicone oil. Among these, dimethyl silicone oil, methyl hydrogen silicone oil, and amino-modified silicone oil are preferable.

The above siloxane compound may be used alone or in combination of two or more.

Viscosity

The viscosity (kinetic viscosity) of the siloxane compound, from the viewpoint of improving fluidity, dispersibility to resin particles, aggregability and adhesiveness to resin particles in the specific silica particles (particularly, from the viewpoint of preventing the fixation of the resin particle composition into a pipe when transporting the resin particle composition using air), is preferably 1,000 cSt to 50,000 cSt, more preferably 2,000 cSt to 30,000 cSt, and further more preferably 3,000 cSt to 10,000 cSt.

The viscosity of the siloxane compound is obtained by the following procedure. Toluene is added to the specific silica particles, and then the specific silica particles are dispersed in the toluene for 30 minutes by an ultrasonic dispersing machine. Thereafter, supernatant is collected. At this time, a toluene solution containing a siloxane compound in a concentration of 1 g/100 ml is obtained. The specific viscosity [ηsp] (25° C.) at this time is obtained by Equation (A) below.

ηsp=(η/η0)−1 Equation (A):

η0: viscosity of toluene, η: viscosity of solution)

Next, the specific viscosity [ηsp] is substituted into the Huggins Equation represented by Equation (B) below, so as to obtain intrinsic viscosity [η].

ηsp=[η]+K′[η]² Equation (B):

(K′: Huggins's constant, K′=0.3 ([η]=1 to 3))

Next, the intrinsic viscosity [η] is substituted into the A. Kolorlov Equation represented by Equation (C) below, so as to obtain molecular weight M.

[η]=0.215×10⁻⁴M^{0.65} Equation (C):

Next, the molecular weight M is substituted into the A. J. Barry Equation represented by Equation (D) below, so as to obtain siloxane viscosity [η].

log η=1.00+0.0123M^{0.5} Equation (D):

Surface Coated Amount

The amount of the siloxane compound adhered to the surface of the specific silica particles, from the viewpoint of improving fluidity, dispersibility to resin particles, aggregability, and adhesiveness to resin particles in the specific silica particles, is preferably 0.01% by weight to 5% by weight, more preferably 0.05% by weight to 3% by weight, and further more preferably 0.10% by weight to 2% by weight with respect to silica particles, on the surface of which the siloxane compound is not adhered, (silica particles before surface treatment).

The surface coated amount is measured by the following method.

100 mg of the specific silica particles are dispersed in 1 ml of chloroform, and 1 μL of DMF (N,N-dimethylformamide), as an internal standard solution, is added thereto, followed by ultrasonic treatment for 30 minutes with an ultrasonic cleaning machine, so as to extract a siloxane compound into the chloroform solvent. Thereafter, hydrogen nucleus spectrum measurement is performed by a JNM-AL400 type nuclear magnetic resonance apparatus (manufactured by JEOL Ltd.), and the amount of the siloxane compound is obtained from the ratio of a siloxane compound-derived peak area to a DMF-derived peak area. Then, the surface coated amount is calculated from the obtained amount of the siloxane compound and the amount of silica particles, from which the siloxane compound is liberated, (silica particles, to the surface of which the siloxane compound is not adhered).

The content of the specific silica particles in each of the resin particle compositions according to the first and second embodiments of the present invention, from the viewpoint of the expression of fluidity of resin particles, the expression of treatability of the resin particle composition, and the transportability of the resin particle composition by using air, is preferably 0.05% by weight to 7.0% by weight, more preferably 0.2% by weight to 4.5% by weight, and further more preferably 0.3% by weight to 3.0% by weight, with respect to the resin particles.

Lubricant particles contained in resin particle composition of first embodiment of the present invention

Next, the lubricant particles contained in the resin particle composition of first embodiment of the present invention will be described.

The lubricant particles may be particles exhibiting lubricity, and examples thereof include fatty acid metal salt particles, inorganic lubricant particles, and resin lubricant particles.

These lubricant particles may be used alone, and may also be used as a mixture of two or more.

Examples of the fatty acid metal salt particles include particles of salts of fatty acids (for example, stearic acid, 12-hydroxystearic acid, palmitic acid, oleic acid, behenic acid, montanic acid, lauric acid, and other organic acids) and metals (for example, calcium, zinc, iron, copper, manganese, lead, magnesium, aluminum, other metals (Na, Li, and the like)).

Among these, from the viewpoint of expression of excellent lubricity, particles of a salt of one fatty acid selected from the group consisting of stearic acid, palmitic acid, oleic acid, and lauric acid and one metal selected from the group consisting of zinc, calcium, iron, copper, magnesium, manganese, and lead are preferable.

Specific examples of the fatty acid metal salt particles include particles of zinc stearate, calcium stearate, iron stearate, copper stearate, zinc palmitate, magnesium palmitate, calcium palmitate, manganese oleate, lead oleate, and zinc laurate.

Among these, as the fatty acid metal salt particles, zinc stearate is preferable, from the viewpoint of high lubricity and easy availability.

The fatty acid metal salt particles may be mixed particles of a plurality of kinds of fatty acid metal salts.

Further, the fatty acid metal salt particles may be particles containing fatty acid metal salts and other components.

Examples of the other components include higher fatty acids and higher alcohols. However, it is preferable that the fatty acid metal salt particles contain 1% by weight or more of a fatty acid metal salt from the viewpoint of expression of lubricity.

Examples of the inorganic lubricant particles include particles having a function of cleaving and lubricating a material itself and particles causing internal slippage.

Specific examples of the inorganic lubricant particles include particles of mica, boron nitride, molybdenum disulfide, tungsten disulfide, talc, kaolinite, montmorillonite, calcium fluoride, and graphite.

Among these, as the inorganic lubricant particles, boron nitride particles are preferable, from the viewpoint of high lubricity.

Examples of the resin lubricant particles include particles of fluorine-based resins, such as polytetrafluoroethylene (PTFE), and particles of low molecular weight polyolefin, such as polypropylene, polyethylene, and polybutene.

Examples of the other lubricant particles include particles of aliphatic amides, such as oleic acid amide, erucic acid amide, ricinoleic acid amide, and stearic acid amide; particles of plant waxes, such as carnauba wax, rice wax, candelilla wax, tree wax, and jojoba oil; particles of animal waxes, such as beeswax; particles of mineral or petroleum waxes, such as Montan wax, ozokerite, ceresin, paraffin wax, microcrystalline wax, and Fischer-Tropsch wax; and modified products thereof.

The selection of the lubricant particles may be performed depending on the resin species constituting the resin particles and general versatility.

From the viewpoint of high general versatility to resin particles and general availability, as the lubricant particles, fatty acid metal salt particles are preferable.

The average circle-equivalent diameter of the lubricant particles by volume may be appropriately determined depending on the particle diameter of the resin particles, but is preferably 0.1 μm to 10.0 μm, more preferably 0.2 μm to 10.0 μm, and further more preferably 0.2 μm to 8.0 μm, from the viewpoint of dispersibility to the resin particles.

The average circle-equivalent diameter of the fatty acid metal salt particles by volume is a value measured by the following method. As the measuring apparatus, a laser diffraction-scattering type particle size measuring apparatus “LA-920” (HORIBA Ltd.) is used. The setting of measurement conditions and the analysis of measurement data are performed using dedicated software “HORIBA LA-920 for windows (registered trademark) WET (LA-920) Ver. 2.02 (HORIBA Ltd.)” belonging to LA-920. Further, as the measurement solvent, ion-exchanged water, from which solid impurities have been previously removed, is used.

Further, the average circle-equivalent diameter of the inorganic lubricant particles by volume is a 50% diameter (D_{50V}) in the cumulative frequency of circle-equivalent diameters obtained by observing 100 primary particles of the inorganic lubricant particles with a scanning electron microscope (SEM) and analyzing the images of the primary particles. The average circle-equivalent diameter of the inorganic lubricant particles by volume is measured by this method.

The content of the lubricant particles in the resin particle composition according to the first embodiment of the present invention, from the viewpoint of the expression of lubricity and the transportability of the resin particle composition through a pipe, is preferably 0.1% by weight to 8% by weight, more preferably 1% by weight to 5% by weight, and further more preferably 2% by weight to 5% by weight, with respect to the resin particles.

Resin particles contained in resin particle composition of first embodiment of the present invention

Next, the resin particles contained in the resin particle composition of the first embodiment of the present invention will be described.

The resin particles are not particularly limited as long as they have a shape, diameter, and material (component) required for adhering the specific silica particles and the lubricant particles to the resin particles. The resin particles may be determined depending on the application purpose of the resin particle composition according to the first embodiment of the present invention.

The shape of the resin particles is not particularly limited, but the volume average particle diameter D_{50V} of the resin particles is preferably 1 μm to 20 μm, more preferably 2 μm to 15 μm, and further more preferably 3 μm to 10 μm, from the viewpoint of easy applicability to transportation by using air and treatability (handling properties). When the volume average particle diameter of the resin particles is within the above range, the deterioration of fluidity of the resin particle composition is easily prevented.

Here, the volume average particle diameter of the resin particles is measured using a Coulter Multisizer II (manufactured by Beckman Coulter, Inc.). In this measurement, ISOTON-II (manufactured by Beckman Coulter, Inc.) is used for measuring an electrolyte.

In the measurement, 0.5 mg to 50 mg of a measurement sample is added to 2 ml of an aqueous solution containing 5% by weight of a surfactant, such as sodium alkylbenzene sulfonate, as a dispersant. This resultant is added to 100 ml to 150 ml of an electrolyte.

The electrolyte in which the sample has been suspended is dispersion-treated for 1 minute with an ultrasonic dispersing machine, and the particle size distribution of particles within a range of 2 μm to 50 μm is measured using an aperture having a diameter of 100 μm by a Coulter Multisizer II. The number of particles to be sampled is 50,000.

The volume average particle diameter D_{50V} is defined by the particle diameter at 50% cumulative volume when drawing the cumulative distribution of the measured particle size distributions with respect to the divided particles size ranges (channels) from small diameter for volume. Specifically, the volume average particle diameter D_{50V} is obtained as follows. The volume average particle diameter D_{50V} at 50% cumulative volume is obtained by drawing a cumulative distribution using the volume distribution obtained by image analysis.

The resin constituting the resin particles is not particularly limited. As the resin constituting the resin particles, thermoplastic resins made of various natural or synthetic polymer materials can be used.

Examples of the resin include polyolefin resins, such as polyethylene and polypropylene; polystyrene resins, such as polystyrene and a acrylonitrile/butadiene/styrene copolymer (ABS resin); acrylic resins, such as polymethyl methacrylate and polybutyl acrylate; rubbery (co)polymers, such as polybutadiene and polyisoprene; polyester resins, such as polyethylene terephthalate and polybutylene terephthalate; vinyl resins, such as vinyl chloride resin, vinyl aromatic resin, and polyvinyl resin; epoxy resins; conjugated diene resins; polyamide resins; polyacetal resins; polycarbonate resins; thermoplastic polyurethane resins; and fluorine resins.

These resins may be used alone or as a mixture of two or more thereof.

As the resin constituting the resin particles, typically, resins having a weight average molecular weight of 5,000 to 100,000 (for example, epoxy resins, styrene-acrylate resins, polyamide resins, polyester resins, polyvinyl resins, polyolefin resins, polyurethane resins, and polybutadiene resins) are exemplified. These resins may be used alone or as a mixture of two or more thereof. The resin may be appropriately selected depending on the intended use. However, from the viewpoint of a resin having high polarity being generally effective and a resin having many polar group on the surface thereof being more effective, the resin is preferably a polyester resin, and the preparation method of the resin is preferably a kneading and pulverizing method.

The resin particles may further contain an additive, such as an ultraviolet absorber or an antioxidant, depending on the intended use.

Method of preparing resin particle composition of first embodiment of the present invention

The resin particle composition according to the first embodiment of the present invention, for example, is prepared by the following method.

That is, the resin particle composition according to the first embodiment of the present invention is prepared through a process of providing specific silica particles, lubricant particles, and resin particles (hereinafter, referred to as a “particle providing process”) and a process of mixing the specific silica particles, lubricant particles and resin particles (hereinafter, referred to as a “particle mixing process”).

Particle Providing Process

First, in the particle providing process, specific silica particles, lubricant particles, and resin particles, which are to be contained in the resin particle composition according to the first embodiment of the present invention, are provided.

Particularly, as the specific silica particles and the resin particles, particles to be prepared by the following method may also be used.

Preparation of release agent-containing resin particles contained in the resin particle composition of second embodiment of the present invention

Next, release agent-containing resin particles contained in the resin particle composition of the second embodiment of the present invention, that is, resin particles, on the surface of which at least a part of a release agent is exposed, will be described.

The release agent-containing resin particles refer to particles which are made of a mixture of a resin, which is a main component, and a release agent, and on the surface of which at least a part of the release agent is exposed.

The release agent-containing resin particles are varied depending on the compatibility between the resin, which is a main component, and the release agent and the melting properties of the release agent. However, in many cases, the release agent-containing resin particles have a structure in which a domain of the release agent exists in the matrix with the resin.

Release Agent

Here, the release agent is not particularly limited as long as it is mixed with a resin, which is a main component, to form particles. However, from the viewpoint of low chemical and physical influences on the resin, easy availability, and safety, preferable examples of the release agent include hydrocarbon waxes; natural waxes, such as carnauba wax, rice wax, and candelilla wax; synthetic or mineral-petroleum waxes, such as montan wax; and ester waxes, such as fatty acid esters and montanic acid ester.

As the release agent, low molecular weight polyolefins, such as polyethylene, polypropylene, and polybutene; and silicones having a softening point by heating may be used in addition to the above-described waxes.

The release agent may be used alone, and may also be used as a combination of two or more thereof.

The content of the release agent is preferably 1% by weight to 20% by weight, and more preferably 5% by weight to 15% by weight, with respect to the total amount of the release agent-containing resin particles.

Resin

The resin constituting the resin particles is not particularly limited.

As the resin constituting the resin particles, thermoplastic resins made of various natural or synthetic polymer materials can be used.

Examples of the resin include polyolefin resins, such as polyethylene and polypropylene; polystyrene resins, such as polystyrene and a acrylonitrile/butadiene/styrene copolymer (ABS resin); acrylic resins, such as polymethyl methacrylate and polybutyl acrylate; rubbery (co)polymers, such as polybutadiene and polyisoprene; polyester resins, such as polyethylene terephthalate and polybutylene terephthalate; vinyl resins, such as vinyl chloride resin, vinyl aromatic resin, and polyvinyl resin; epoxy resins; conjugated diene resins; polyamide resins; polyacetal resins; polycarbonate resins; thermoplastic polyurethane resins; and fluorine resins.

These resins may be used alone or as a mixture of two or more thereof.

As the resin constituting the resin particles, typically, resins having a weight average molecular weight of 5,000 to 100,000 (for example, epoxy resins, styrene-acrylate resins, polyamide resins, polyester resins, polyvinyl resins, polyolefin resins, polyurethane resins, and polybutadiene resins) are exemplified.

The resin may be appropriately selected depending on the intended use.

Additives

The release agent-containing resin particles may further contain additives, such as an ultraviolet absorber and an antioxidant, as components other than the release agent and the resin, depending on the intended use.

Physical Properties and the Like

The release agent-containing resin particles are not particularly limited as long as they have a shape, structure, diameter, and material (component) required for easily adhering external additives including the specific silica particles to the resin particles. The release agent-containing resin particles may be determined depending on the application purpose of the resin particle composition according to the second embodiment of the present invention.

Volume Average Particle Diameter

The shape of the release agent-containing resin particles is not particularly limited, but the volume average particle diameter D_{50V} thereof is preferably 1 μm to 20 μm, more preferably 2 μm to 15 μm, and further more preferably 3 μm to 10 μm, from the viewpoint of easy applicability to transportation by using air and treatability (handling properties). When the volume average particle diameter of the release agent-containing resin particles is within the above range, the deterioration of fluidity of the resin particle composition is easily prevented.

Here, the volume average particle diameter of the release agent-containing resin particles is measured using a Coulter Multisizer II (manufactured by Beckman Coulter, Inc.). In this measurement, ISOTON-II (manufactured by Beckman Coulter, Inc.) is used for measuring an electrolyte.

In the measurement, 0.5 mg to 50 mg of a measurement sample is added to 2 ml of an aqueous solution containing 5% by weight of a surfactant, such as sodium alkylbenzene sulfonate, as a dispersant. This resultant is added to 100 ml to 150 ml of an electrolyte.

The electrolyte in which the sample has been suspended is dispersion-treated for 1 minute with an ultrasonic dispersing machine, and the particle size distribution of particles within a range of 2 μm to 50 μm is measured using an aperture having a diameter of 100 μm by a Coulter Multisizer II. The number of particles to be sampled is 50,000.

The volume average particle diameter D_{50V} is defined by the particle diameter at 50% cumulative volume when drawing the cumulative distribution of the measured particle size distributions with respect to the divided particles size ranges (channels) from small diameter for volume. Specifically, the volume average particle diameter D_{50V} is obtained as follows. The volume average particle diameter D_{50V} at 50% cumulative volume is obtained by drawing a cumulative distribution using the volume distribution obtained by image analysis.

Structure

The release agent-containing resin particles, from the viewpoint of expression of releasing properties by the release agent, have a structure in which at least a part of the release agent is exposed to the surface of the resin particles.

Here, in the structure in which at least a part of the release agent is exposed to the surface of the resin particles, for example, ruthenium dyeing is carried out by a general method, but an aqueous 0.5% ruthenium tetroxide solution is used in the dyeing. By the ruthenium dyeing, the release agent is diluted, and dyed in a color different from that of the resin, and surface exposure is observed by an scanning electron microscope (SEM), thereby confirming the structure of the release agent-containing resin particles.

It is preferable that the release agent-containing resin particles having a structure in which at least a part of the release agent is exposed to the surface of the resin particles are prepared by a dry method, such as a kneading and pulverizing method.

The release agent-containing resin particles prepared by the kneading and pulverizing method have a irregular shape. However, in the case where the release agent-containing resin particles are combined with the specific silica particles, even when a small amount of the specific silica particles is used, the fluidity of the resin particles is secured, and the fixation of the resin particle composition into a pipe at the time of transporting the resin particle composition by using air is prevented.

Accordingly, in the resin particle composition according to the second embodiment of the present invention, even when at least a part of the release agent is exposed to the surface of the resin particles and the resin particles have a irregular shape, the fluidity of the resin particles and the treatability of the resin particle composition are excellent, and the fixation of the resin particle composition into a pipe at the time of transporting the resin particle composition by using air is prevented.

The method of preparing the release agent-containing resin particles by the kneading and pulverizing method will be described later.

Average Circularity Degree

In the case where the shape of the release agent-containing resin particles is irregular, the average circularity degree of such resin particles is preferably 0.90 to 0.95, and more preferably 0.92 to 0.94.

The circularity degree of the release agent-containing resin particles is obtained by observing the primary particles of the release agent-containing resin particles with a SEM apparatus, and is a value measured and calculated in the same manner as the specific silica particles.

Exposure Rate of Release Agent

In the case of the resin particles having a structure in which at least a part of the release agent is exposed to the surface of the resin particles, the exposure rate of the release agent (exposure rate of the release agent on the surface of the release agent-containing resin particles) is preferably 5% by atom to 40% by atom, and more preferably 10% by atom to 25% by atom.

Here, the exposure rate of the release agent is a value obtained by X-ray photoemission spectroscopy (XPS) measurement. As the XPS measurement apparatus, JPS-9000MX, manufactured by JEOL Ltd., is used. In the measurement, an MgK α-ray is used as an X-ray source, an accelerating voltage is set to 10 kV, and an emission current is set to 30 mA. Here, the amount of the release agent on the surface release agent-containing resin particles is quantified by peak separation of CIS spectra. In the peak separation, each component is separated using curve fitting by a least-square method of the measured CIS spectra. In the component spectra serving as a base of separation, CIS spectra, which obtained by measuring the resin and release agent used in the preparation of the release agent-containing resin particles, are used.

Method of preparing resin particle composition of second embodiment of the present invention

The resin particle composition according to the second embodiment of the present invention, for example, is prepared by the following method.

That is, the resin particle composition according to the second embodiment of the present invention is prepared through a process of providing specific silica particles and release agent-containing resin particles (hereinafter, referred to as a “particle providing process”) and a process of mixing the specific silica particles and the release agent-containing resin particles (hereinafter, referred to as a “particle mixing process”).

Particle Providing Process

First, in the particle providing process, specific silica particles and release agent-containing resin particles, which are to be contained in the resin particle composition according to the second embodiment of the present invention, are provided.

As the specific silica particles and the resin particles, particles to be prepared by the following method may also be used.

Preparation of specific silica particles of first and second embodiments of the present invention

The specific silica particles are obtained by surface-treating the surface of silica particles with a siloxane compound having a viscosity of 1,000 cSt to 50,000 cSt such that the surface coated amount of the silica particles is 0.01% by weight to 5% by weight.

As the surface treatment method, a method of surface-treating the surface of silica particles with a siloxane compound in supercritical carbon dioxide and a method of surface-treating the surface of silica particles with a siloxane compound in the air are exemplified.

Specific examples of the surface treatment method include: a method of adhering a siloxane compound to the surface of silica particles by dissolving the siloxane compound in supercritical carbon dioxide; a method of adhering a siloxane compound to the surface of silica particles by applying (for example, spraying or coating) a solution including a siloxane compound and a solvent dissolving the siloxane compound to the surface of silica particles in the air; and a method of adding a solution including a siloxane compound and a solvent dissolving the siloxane compound to a silica particle dispersion and then drying a mixed solution of the silica particle dispersion and the solution.

Here, the “supercritical carbon dioxide” is carbon dioxide existing in the state of temperature and pressure more than the critical point, and has both diffusivity of gas and solubility of liquid.

Among these surface treatment methods, a method of adhering a siloxane compound to the surface of silica particles using supercritical carbon dioxide is preferable.

When the surface treatment is performed in supercritical carbon dioxide, there becomes a state in which the siloxane compound is dissolved in the supercritical carbon dioxide. Since the supercritical carbon dioxide has low interfacial tension, it is considered that the siloxane compound existing in the state of being dissolved in the supercritical carbon dioxide diffuses deeply into the holes of the surface of silica particles together with supercritical carbon dioxide to easily reach the hole, and it is considered that the surface treatment with the siloxane compound is performed in the hole as well as on the surface of silica particles.

Therefore, it is considered that the silica particles surface-treated with the siloxane compound in the supercritical carbon dioxide are silica particles treated in a state of the surface thereof being substantially uniform (for example, in a state of a surface treated layer being formed in the shape of a thin film).

Further, surface treatment of imparting hydrophobicity to the surface of silica particles by using a hydrophobizing agent together with the siloxane compound in the supercritical carbon dioxide may be performed.

In this case, there becomes a state in which both the hydrophobizing agent and the siloxane compound are dissolved in the supercritical carbon dioxide. It is considered that the siloxane compound and hydrophobizing agent existing in the state of being dissolved in the supercritical carbon dioxide diffuse deeply into the holes of the surface of silica particles together with supercritical carbon dioxide to easily reach the hole, and it is considered that the surface treatment with the siloxane compound and the hydrophobizing agent is performed in the hole as well as on the surface of silica particles.

As a result, the silica particles surface-treated with the siloxane compound and the hydrophobizing agent in the supercritical carbon dioxide are easily adhered to the surface of silica particles in a state of the surface thereof being substantially uniform, so as to impart high hydrophobicity to the surface of silica particles.

It is preferable that the specific silica particles are prepared by the following method. As the method of preparing the specific silica particles, there is exemplified a method of preparing silica particles, including: a process of providing a silica particle dispersion containing silica particles and a solvent including alcohol and water (hereinafter, referred to as “dispersion providing process”); removing the solvent from the silica particle dispersion by circulating supercritical carbon dioxide (hereinafter, referred to as “solvent removing process”); and surface-treating the surface of the silica particle with a siloxane compound in the supercritical carbon dioxide after removing the solvent (hereinafter, referred to as “surface treatment process”).

As described above, when the process of removing the solvent from the silica particle dispersion is performed using the supercritical carbon dioxide, it is easy to prevent the formation of coarse powder.

The reason for this is not clear, but is considered as follows. 1) In the case of removing the solvent from the silica particle dispersion, since the supercritical carbon dioxide has a property of “interfacial tension not operating”, the solvent can be removed without the aggregation of particles by the liquid crosslinking force at the time of removing the solvent, and 2) since the supercritical carbon dioxide is “carbon dioxide existing in the state of temperature and pressure more than the critical point and has a property of having both diffusivity of gas and solubility of liquid”, the silica particle dispersion effectively comes into contact with the supercritical carbon dioxide at a relatively low temperature (for example, 250° C. or lower) to allow the supercritical carbon dioxide in which the solvent is dissolved to be removed, thereby removing the solvent from the silica particle dispersion without the formation of coarse powder, such as secondary aggregates, by the condensation of silanol groups.

Here, the solvent removing process and the surface treatment process may be separately performed, but, preferably, may also be continuously performed (that is, each process is performed in a non-open state at atmospheric press). When these processes are continuously performed, the chance of silica particles adsorbing moisture disappears after the solvent removing process, and thus the surface treatment process can be performed in a state in which the adsorption of excess moisture to silica particles is prevented.

Therefore, it is not required to use a large amount of a siloxane compound, and it is not required to perform the solvent removing process and the surface treatment process at high temperature at which excessive heating is performed. As a result, it is easy to prevent the formation of coarse powder more effectively.

Hereinafter, the above-described dispersion providing process, solvent removing process and surface treatment process will be described in detail.

The method of preparing specific silica particles is not limited to a method including the above three processes, and, for example, may be 1) an aspect in which supercritical carbon dioxide is used only in the surface treatment process, or 2) an aspect in which each process is separately performed.

Dispersion Providing Process

In the dispersion providing process, for example, a silica particle dispersion containing silica particles and a solvent including alcohol and water is provided.

Specifically, in the dispersion providing process, for example, a silica particle dispersion is prepared by a wet process (for example, a sol-gel process), and this silica particle dispersion is provided.

In particular, silica particles are formed by a sol-gel process as a wet process, specifically, by causing the reactions (hydrolysis reaction and condensation reaction) of tetraalkoxysilane with a solvent of alcohol and water in the presence of an alkali catalyst, and a silica particle dispersion is prepared using these silica particles.

The preferable range of average circle-equivalent diameter of silica particles and the preferable range of average circularity degree thereof have been described as above. It is preferable that silica particles (untreated silica particles) are prepared within these ranges.

In the dispersion providing process, for example, in the case where silica particles are obtained by a wet process, the silica particles are obtained in the form of a dispersion (silica particle dispersion) in which silica particles are dissolved in a solvent.

When the solvent removing process is performed, in the prepared silica particle dispersion, the weight ratio of silica particles to the silica particle dispersion, for example, may be 0.05 to 0.7, preferably 0.2 to 0.65, and more preferably 0.3 to 0.6.

When the weight ratio of silica particles to the silica particle dispersion is below 0.05, the amount of supercritical carbon dioxide used in the solvent removing process increases, and thus productivity deteriorates.

Further, when the weight ratio of silica particles to the silica particle dispersion is above 0.7, the distance between silica particles in the silica particle dispersion decreases, and thus coarse powder is easily formed due to the aggregation or gelation of silica particles.

Solvent Removing Process

The solvent removing process, for example, is a process of removing a solvent from the silica particle dispersion by circulating supercritical carbon dioxide.

That is, in the solvent removing process, supercritical carbon dioxide is brought into contact with the silica particle dispersion by circulating the supercritical carbon dioxide, so as to remove a solvent from the silica particle dispersion.

Specifically, in the solvent removing process, for example, the silica particle dispersion is put into a sealed reactor. Then, liquefied carbon dioxide is introduced into the sealed reactor, the sealed reactor is heated, and then the pressure in the reactor is increased by a high-pressure pump, so as to set the carbon dioxide to a supercritical state. Further, the supercritical carbon dioxide is introduced into the sealed reactor and discharged from the sealed reactor, thereby circulating the supercritical carbon dioxide in the sealed reactor, that is, the silica particle dispersion.

Thus, the supercritical carbon dioxide is discharged to the outside of the silica particle dispersion (outside of the sealed reactor) while dissolving a solvent (alcohol and water), so as to remove the solvent.

The temperature condition for solvent removal, that is, the temperature of the supercritical carbon dioxide may be 31° C. to 350° C., preferably 60° C. to 300° C., and more preferably 80° C. to 250° C.

When this temperature is lower than 31° C., it is difficult to allow the solvent to be dissolved in the supercritical carbon dioxide, and thus it is difficult to remove the solvent. Further, it is considered that coarse powder is easily formed by the liquid crosslinking force of the solvent or the supercritical carbon dioxide. Meanwhile, when this temperature is higher than 350° C., it is considered that coarse powder, such as secondary aggregates, is easily formed by the condensation of silanol groups of the surface of silica particles.

The pressure condition for solvent removal, that is, the pressure of the supercritical carbon dioxide may be 7.38 MPa to 40 MPa, preferably 10 MPa to 35 MPa, and more preferably 15 MPa to 25 MPa.

When this pressure is lower than 7.38 MPa, there is a tendency that it is difficult to allow the solvent to be dissolved in the supercritical carbon dioxide. In contrast, when this pressure is higher than 40 MPa, there is a tendency that equipment cost is high.

The amount of supercritical carbon dioxide introduced into the sealed reactor and discharged from the sealed reactor, for example, may be 15.4 L/min/m³ to 1540 L/min/m³, and preferably 77 L/min/m³ to 770 L/min/m³.

When the introduction and discharge amount thereof is less than 15.4 L/min/m³, it takes time to remove a solvent, and thus there is a tendency that productivity easily deteriorates. In contrast, when the introduction and discharge amount thereof is more than 1540 L/min/m³, supercritical carbon dioxide short-passed, so that the contact time of the silica particle dispersion becomes shorter, and thus there is a tendency that it is difficult to efficiently remove a solvent.

Surface Treatment Process

The surface treatment process, for example, is a process of surface-treating the surface of silica particles with a silxoane compound in the supercritical carbon dioxide, after the solvent removing process.

That is, in the surface treatment process, for example, after the solvent removing process, the surface of silica particles is treated with a siloxane compound in the supercritical carbon dioxide without opening to the air.

Specifically, in the surface treatment process, for example, after stopping the introduction of supercritical carbon dioxide into the sealed reactor and the discharge of supercritical carbon dioxide from the sealed reactor in the solvent removing process, the temperature and pressure in the sealed reactor are adjusted, and a siloxane compound is put into the sealed reactor at a predetermined ratio to silica particles in a state in which the supercritical carbon dioxide existing in the sealed reactor. Then, the surface treatment of silica particles is performed by reacting a siloxane compound with silica particles while maintaining this state, that is, in the supercritical carbon dioxide.

Here, in the surface treatment process, the reaction of a siloxane compound may be performed in the supercritical carbon dioxide (that is, under an atmosphere of supercritical carbon dioxide), and surface treatment may be performed while circulating supercritical carbon dioxide (that is, while introducing supercritical carbon dioxide into the sealed reactor and discharging the supercritical carbon dioxide from the sealed reactor) and may also be performed without circulating.

In the surface treatment process, the amount (that is, charged amount) of silica particles with respect to the volume of the reactor, for example, may be 30 g/L to 600 g/L, preferably 50 g/L to 500 g/L, and more preferably 80 g/L to 400 g/L.

When the amount thereof is less than 30 g/L, the concentration of a siloxane compound to supercritical carbon dioxide is decreased to decrease the probability of contact with silica surface, and thus reaction is less likely to proceed. In contrast, when the amount thereof is more than 600 g/L, the concentration of a siloxane compound to supercritical carbon dioxide is increased, so that the siloxane compound is not completely dissolved in the supercritical carbon dioxide to cause poor dispersion, and thus coarse aggregates are easily formed.

The density of supercritical carbon dioxide, for example, may be 0.10 g/ml to 0.80 g/ml, preferably 0.10 g/ml to 0.60 g/ml, and more preferably 0.2 g/m1 to 0.50 g/ml.

When the density thereof is lower than 0.10 g/ml, the solubility of a siloxane compound to supercritical carbon dioxide is decreased, and thus there is a tendency to form aggregates. In contrast, when the density thereof is higher than 0.80 g/ml, the diffusivity of silica particles into holes is deteriorated, and thus there is a case where surface treatment becomes insufficient. Particularly, the surface treatment of sol-gel silica particles containing many silanol groups may be performed within the above density range.

The density of supercritical carbon dioxide is adjusted by temperature, pressure, and the like.

The temperature condition for surface treatment, that is, the temperature of the supercritical carbon dioxide may be 80° C. to 300° C., preferably 100° C. to 250° C., and more preferably 120° C. to 200° C.

When the temperature thereof is lower than 80° C., the surface treatment capacity by a siloxane compound is deteriorated. In contrast, when the temperature thereof is higher than 300° C., the condensation reaction between silanol group of silica particles proceeds, and thus particle aggregation occurs. Particularly, the surface treatment of sol-gel silica particles containing many silanol groups may be performed within the above temperature range.

The pressure condition for surface treatment, that is, the pressure of the supercritical carbon dioxide, for example, may be 8 MPa to 30 MPa, preferably 10 MPa to 25 MPa, and more preferably 15 MPa to 20 MPa, as long as the pressure condition is a condition satisfying the above density.

Specific examples of the siloxane compound used in the surface treatment have been described as above. Further, the preferable range of viscosity of the siloxane compound has also been described as above.

Among the above siloxane compounds, when silicone oil is applied, the silicone oil easily adheres to the surface of silica particles in an almost uniform state, and thus the fluidity, dispersibility and treatability of silica particles are easily improved.

The amount of the siloxane compound to be used, from the viewpoint of easily controlling the surface coated amount of the siloxane compound to silica particles within the range of 0.01% by weight to 5% by weight, for example, may be 0.05% by weight to 3% by weight, preferably 0.1% by weight to 2% by weight, and more preferably 0.15% by weight to 1.5% by weight, with respect to the silica particles.

The siloxane compound may be used alone, but may be used as a mixed solution in which the siloxane compound is mixed with a solvent easily dissolving the siloxane compound. Examples of the solvent include toluene, methyl ethyl ketone, and methyl isobutyl ketone.

In the surface treatment process, the surface treatment of silica particles may be performed by a mixture including a hydrophobizing agent together with the siloxane compound.

As the hydrophobizing agent, for example, a silane-based hydrophobizing agent is exemplified. As the silane-based hydrophobizing agent, a known silicon compound having an alkyl group (for example, a methyl group, an ethyl group, a propyl group, or a butyl group) is exemplified, and specific examples thereof include silazane compounds (for example, silane compounds, such as methyltrimethoxysilane, dimethyldimethoxysilane, trimethylchlorosilane, and trimethylmethoxysilane; hexamethyldisilazane; and tetramethyldisilazane). These hydrophobizing agents may be used alone, and may also be used in a combination of two or more thereof.

Among the silane-based hydrophobizing agents, a silicon compound having a trimethyl group, such as trimethylmethoxysilane or hexamethyldisilazane (HMDS), particularly, hexamethyldisilazane (HMDS) is preferable.

The amount of the hydrophobizing agent to be used is not particularly limited, but, for example, may be 1% by weight to 100% by weight, preferably 3% by weight to 80% by weight, and more preferably 5% by weight to 50% by weight, with respect to the silica particles.

The hydrophobizing agent may be used alone, but may be used as a mixed solution in which the silane-based hydrophobizing agent is mixed with a solvent easily dissolving the silane-based hydrophobizing agent. Examples of the solvent include toluene, methyl ethyl ketone, and methyl isobutyl ketone.

Preparation of resin particles contained in resin particle composition of first embodiment of the present invention

The preparation method of the resin particles may be determined depending on the kind and particle shape of a resin, and is not particularly limited.

The resin particles may be prepared by a method of molten-kneading a resin and then pulverizing and classifying the molten-kneaded product (kneading and pulverizing method), a method of suspending and dispersing an oil phase, obtained by dissolving a resin in a water-soluble organic solvent, in an aqueous phase containing a dispersant and then removing the solvent (dissolution suspension method), or a method of aggregating a resin, obtained by the emulsion polymerization of resin monomers, and then making the resin aggregates into particles (emulsion polymerization aggregation method).

Particle Mixing Process

In the particle mixing process, specific silica particles, lubricant particles, and resin particles are mixed.

In the mixing of specific silica particles, lubricant particles, and resin particles, a V-type blender, a HENSCHEL MIXER, or a LODIGE MIXER is used.

Specific silica particles and lubricant particles may be separately mixed with resin particles.

Preparation of release agent-containing resin particles contained in resin particle composition of second embodiment of the present invention

The preparation method of the release agent-containing resin particles may be determined depending on the kind and particle shape of a resin and a release agent, and is not particularly limited.

The release agent-containing resin particles may be prepared by a method of molten-kneading a resin and a releasing agent then pulverizing and classifying the molten-kneaded product (kneading and pulverizing method), a method of suspending and dispersing an oil phase, obtained by dissolving a resin and a release agent in a water-soluble organic solvent, in an aqueous phase containing a dispersant and then removing the solvent (dissolution suspension method), or a method of aggregating a resin, obtained by the emulsion polymerization of resin monomers, together with a release agent, and then making the resin aggregates into particles (emulsion polymerization aggregation method).

Kneading and Pulverizing Method

As described above, it is preferable that the resin particles, on the surface of which at least a part of a release agent is exposed, and which have a irregular shape, are prepared by a kneading and pulverizing method.

According to the kneading and pulverizing method, particles are broken and pulverized at the portion of the release agent, so as to obtain resin particles which have a irregular shape and in which at least a part of the release agent is exposed.

The kneading and pulverizing method is a method of molten-kneading a resin and a releasing agent then pulverizing and classifying the molten-kneaded product. Specifically, for example, the kneading and pulverizing method includes a kneading process of molten-kneading a resin and a releasing agent, a cooling process of cooling the molten-kneaded product, a pulverization process of pulverizing the kneaded product after the cooling, and a classification process of classifying the pulverized product.

Hereinafter, each process of the kneading and pulverizing method will be described in detail.

Kneading Process

In the kneading process, a resin particle forming material containing a resin and a release agent is molten-kneaded.

Examples of the kneader used in the kneading process include a three-roll type kneader, a single-screw type kneader, a double-screw type kneader, and a Banbury mixer type kneader.

Kneading temperature may be determined depending on the kind and combination ratio of the resin and releasing agent to be kneaded.

Cooling Process

The cooling process is a process of cooling the kneaded product formed in the above kneading process.

In the cooling process, in order to keep the dispersion state immediately after the kneading process, preferably, the knead product is cooled from the temperature at the time of completing the kneading process to 40° C. at an average temperature decrease rate of 4° C./sec.

The average temperature decrease rate refers to an average value of temperature decrease rates at which the temperature of the kneaded product at the time of completing the kneading process decreases to 40° C.

As a cooling method in the cooling process, specifically, for example, there is exemplified a method using a mill roll or a pinch type cooling belt through which cold water or brine is circulated. In the case where cooling is performed by this method, the cooling rate thereof is determined by the speed of the mill roll, the flow rate of the brine, the supply rate of the kneaded product, the slab thickness of the knead product at the time of rolling, or the like. The slab thickness is preferably 1 mm to 3 mm.

Pulverization Process

The kneaded product cooled by the cooling process is pulverized by the pulverization process to form particles.

In the pulverization process, for example, a mechanical pulverizer, a jet pulverizer, or the like is used.

Classification Process The pulverized product (particles) obtained by the pulverization process, if necessary, may be classified by the classification process in order to obtain resin particles having a volume average particle diameter within the intended range.

In the classification process, a conventionally used centrifugal classifier, an inertial classifier, or the like is used. In the classification process, fine particles (particles having a particle diameter smaller than the particle diameter within the intended range) and coarse particles (particles having a particle diameter larger than the particle diameter within the intended range) are removed.

Through the above processes, the resin particles, on the surface of which at least a part of a release agent is exposed, and which have a irregular shape, are obtained.

Particle Mixing Process

In the particle mixing process, specific silica particles and release agent-containing resin particles are mixed.

In the mixing of specific silica particles and release agent-containing resin particles, a V-type blender, a HENSCHEL MIXER, or a LODIGE MIXER is used.

### EXAMPLES

Hereinafter, the present invention will be described in more detail with reference to Examples. However, the present invention is not limited to these Examples. Here, “parts” and “%” are based on weight, unless otherwise specified.

Preparation of Silica Particle Dispersion (1)

300 parts of methanol and 70 parts of 10% aqueous ammonia are put into a 1.5 L glass reaction container provided with a stirrer, a dropping nozzle, and a thermometer, and mixed with each other, so as to obtain an alkali catalyst solution.

The alkali catalyst solution is adjusted to 30° C., and then 185 parts of tetramethoxysilane and 50 parts of 8.0% aqueous ammonia are simultaneously dropped thereinto while stirring, so as to obtain a hydrophilic silica particle dispersion (solid concentration: 12.0% by weight). Here, dropping time is set to 30 minutes.

Thereafter, the obtained silica particle dispersion is concentrated to have a solid concentration of 40% by weight by a rotary filter R-FINE (manufactured by KOTOBUKI Industry Co., Ltd.). This concentrated product is defined as silica particle dispersion (1).

Preparation of Silica Particle Dispersions (2) to (8)

Silica particle dispersions (2) to (8) are prepared in the same manner as in the preparation of the silica particle dispersion (1), except that the alkali catalyst solution (content of methanol and content of 10% aqueous ammonia) and silica particle formation conditions (total dropping amount of tetramethoxysilane (represented by TMOS) into the alkali catalyst solution, total dropping amount of 8% aqueous ammonia into the alkali catalyst solution, and dropping time) are changed according to Table 1.

Silica particle dispersions (1) to (8) are summarized in Table 1.

TABLE 1

| | | | Silica particle formation condition | | |
|---|---|---|---|---|---|
| | | | Total | Total | |
| | Alkali catalyst solution | | dropping | dropping | |
| | | 10% | amount | amount of | |
| Silica | | aqueous | of | 8% aqueous | Dropping |
| particle | Methanol | ammonia | TMOS | ammonia | time |
| dispersion | (parts) | (parts) | (parts) | (parts) | (min) |
| (1) | 300 | 70 | 185 | 50 | 30 |
| (2) | 300 | 70 | 340 | 92 | 55 |
| (3) | 300 | 46 | 40 | 25 | 30 |
| (4) | 300 | 70 | 62 | 17 | 10 |
| (5) | 300 | 70 | 700 | 200 | 120 |
| (6) | 300 | 70 | 500 | 140 | 85 |
| (7) | 300 | 70 | 1000 | 280 | 170 |
| (8) | 300 | 70 | 3000 | 800 | 520 |

Preparation of Surface-treated Silica Particles (S1)

The surface treatment of silica particles with a siloxane compound is performed under supercritical carbon dioxide atmosphere using the silica particle dispersion (1) as follows. In the surface treatment, an apparatus equipped with a carbon dioxide cylinder, a carbon dioxide pump, an entrainer pump, a stirrer-equipped autoclave (capacity: 500 mL), and a pressure valve is used.

First, 250 parts of the silica particle dispersion (1) is put into the stirrer-equipped autoclave (capacity: 500 mL), and the stirrer is rotated at 100 rpm. Then, liquefied carbon dioxide is injected into the autoclave, and the pressure in the autoclave is increased by the carbon dioxide pump while increasing the temperature in the autoclave by a heater, so as to set the inside of the autoclave to a supercritical state of 150° C. and 15 MPa. Then, methanol and water are removed from the silica particle dispersion (1) by circulating supercritical carbon dioxide using the carbon dioxide pump while maintaining the pressure in the autoclave at 15 MPa using the pressure valve (solvent removing process), so as to obtain silica particles (untreated silica particles).

Next, the circulation of supercritical carbon dioxide is stopped at the time that the circulation amount of circulated supercritical carbon dioxide (accumulated amount are measured as the circulation amount of carbon dioxide in the standard state) becomes 900 parts.

Then, in a state in which the temperature is maintained at 150° C. by the heater, the pressure is maintained at 15 MPa by the carbon dioxide pump, and the supercritical state of carbon dioxide in the autoclave is maintained, a treatment agent solution, which is obtained in advance by dissolving 0.3 parts of dimethyl silicone oil (DSO: trade name “KF-96”, manufactured by Shin-Etsu Chemical Co., Ltd.) having a viscosity of 10,000 cSt, as a siloxane compound, in 20 parts of hexamethyldisilazane (HMDS, manufactured by YUKI GOSEI KOGYO CO., LTD.), as a hydrophobizing agent, is injected into the autoclave by the entrainer pump, and then reacted with respect to 100 parts of the above silica particles (untreated silica particles) for 20 minutes at 180° C. with stirring. Then, the supercritical carbon dioxide is circulated again, so as to remove the excess treatment agent solution. Then, stirring is stopped, the pressure in the autoclave is reduced to atmospheric pressure by opening the pressure valve, and the temperature in the autoclave is reduced to room temperature (25° C.).

As such, the solvent removing process and the surface treatment with the siloxane compound are sequentially performed, so as to obtain surface-treated silica particles (S1).

Preparation of surface-treated silica particles (S2) to (S5), (S7) to (S9), and (S12) to (S17)

Surface-treated silica particles (S2) to (S5), (S7) to (S9), and (S12) to (S17) are prepared in the same manner as in the preparation of the surface-treated silica particles (S1), except that silica particle dispersion and surface treatment condition (treatment atmosphere, siloxane compound (kind, viscosity, and addition amount), and hydrophobizing agent and addition amount thereof) are changed according to Table 2.

Preparation of Surface-treated Silica Particles (S6)

The surface treatment of silica particles with a siloxane compound is performed under the air atmosphere using a dispersion which is the same as the silica particle dispersion (1) used in the preparation of the surface-treated silica particles (S1) as follows.

An ester adapter and a cooling tube are mounted in the reaction container used in the preparation of the silica particle dispersion (1), the silica particle dispersion (1) is heated to 60° C. to 70° C. to remove methanol, water is added thereto, and this dispersion is further heated to 70° C. to 90° C. to remove methanol, so as to obtain an aqueous dispersion of silica particles. 3 parts of methyl trimethoxysilane (MTMS, manufactured by Shin-Etsu Chemical Co., Ltd.) is added at room temperature with respect to 100 parts of solid content of silica particles in the aqueous dispersion, and a reaction is performed for 2 hours, so as to perform the surface treatment of silica particles. Methyl isobutyl ketone is added to the surface-treated dispersion, and then the dispersion is heated to 80° C. to 110° C. to remove methanol. Then, 80 parts of hexamethyldisilazane (HMDS, manufactured by YUKI GOSEI KOGYO CO., LTD.) and 1.0 part of dimethyl silicone oil (DSO: trade name “KF-96”, manufactured by Shin-Etsu Chemical Co., Ltd.) having a viscosity of 10000 cSt, as a siloxane compound, are added at room temperature with respect to 100 parts of solid content of silica particles in the obtained dispersion, followed by a reaction at 120° C. for 3 hours, cooling, and drying by spray drying, so as to obtain surface-treated silica particles (S6).

Preparation of Surface-treated Silica Particles (S10)

Surface-treated silica particles (S10) are prepared in the same manner as in the preparation of the surface-treated silica particles (S1), except that fumed silica (“AEROSIL OX50”, manufactured by Nippon Aerosil Co., Ltd.) is used instead of the silica particles (untreated silica particles) obtained by removing methanol and water from the silica particle dispersion (1).

That is, 100 parts of AEROSIL OX50 is put into the stirrer-equipped autoclave, which is the same as that used in the preparation of the surface-treated silica particles (S1), and the stirrer is rotated at 100 rpm. Then, liquefied carbon dioxide is injected into the autoclave, and the pressure in the autoclave is increased by the carbon dioxide pump while increasing the temperature in the autoclave by a heater, so as to set the inside of the autoclave to a supercritical state of 180° C. and 15 MPa. Then, in a state in which the pressure in the autoclave is maintained at 15 MPa by the pressure valve, a treatment agent solution, which is obtained in advance by dissolving 0.3 parts of dimethyl silicone oil (DSO: trade name “KF-96”, manufactured by Shin-Etsu Chemical Co., Ltd.) having a viscosity of 10000 cSt, as a siloxane compound, in 20 parts of hexamethyldisilazane (HMDS, manufactured by YUKI GOSEI KOGYO CO., LTD.), as a hydrophobizing agent, is injected into the autoclave by the entrainer pump, followed by a reaction with respect to 100 parts of the above silica particles (untreated silica particles)for 20 minutes at 180° C. with stirring. Then, the supercritical carbon dioxide is circulated to remove excess treatment agent solution, so as to obtain surface-treated silica particles (S10).

Preparation of Surface-treated Silica Particles (S11)

Surface-treated silica particles (S11) are prepared in the same manner as in the preparation of the surface-treated silica particles (S1), except that fumed silica (“AEROSIL A50”, manufactured by Nippon Aerosil Co., Ltd.) is used instead of the silica particles (untreated silica particles) obtained by removing methanol and water from the silica particle dispersion (1).

That is, 100 parts of AEROSIL A50 is put into the stirrer-equipped autoclave, which is the same as that used in the preparation of the surface-treated silica particles (S1), and the stirrer is rotated at 100 rpm. Then, liquefied carbon dioxide is injected into the autoclave, and the pressure in the autoclave is increased by the carbon dioxide pump while increasing the temperature in the autoclave by a heater, so as to set the inside of the autoclave to a supercritical state of 180° C. and 15 MPa. Then, in a state in which the pressure in the autoclave is maintained at 15 MPa by the pressure valve, a treatment agent solution, which is obtained in advance by dissolving 1.0 part of dimethyl silicone oil (DSO: trade name “KF-96”, manufactured by Shin-Etsu Chemical Co., Ltd.) having a viscosity of 10000 cSt, as a siloxane compound, in 40 parts of hexamethyldisilazane (HMDS, manufactured by YUKI GOSEI KOGYO CO., LTD.), as a hydrophobizing agent, is injected into the autoclave by the entrainer pump, followed by a reaction with respect to 100 parts of the above silica particles (untreated silica particles) for 20 minutes at 180° C. with stirring. Then, the supercritical carbon dioxide is circulated to remove excess treatment agent solution, so as to obtain surface-treated silica particles (S11).

Preparation of Surface-treated Silica Particles (SC1)

Surface-treated silica particles (SC1) are prepared in the same manner as in the preparation of the surface-treated silica particles (S1), except that a siloxane compound is not added.

Preparation of Surface-treated Silica Particles (SC2) to (SC4)

Surface-treated silica particles (SC2) to (SC4) are prepared in the same manner as in the preparation of the surface-treated silica particles (S1), except that silica particle dispersion and surface treatment condition (treatment atmosphere, siloxane compound (kind, viscosity, and addition amount), and hydrophobizing agent and addition amount thereof) are changed according to Table 3.

Preparation of Surface-treated Silica Particles (SC5)

Surface-treated silica particles (SC5) are prepared in the same manner as in the preparation of the surface-treated silica particles (S6), except that a siloxane compound is not added.

Preparation of Surface-treated Silica Particles (SC6)

The silica particle dispersion (8) is filtered, dried at 120° C., put into an electrical furnace, and then sintered at 400° C. for 6 hours. Then, 10 parts of HMDS is added with respect to 100 parts of silica particles, followed by spraying and drying, so as to obtain surface-treated silica particles (SC6).

The average circle-equivalent diameter, average circularity degree, amount of siloxane compound adhered to untreated silica particles, compression aggregation degree, particle compression ratio, and particle dispersion degree of the surface-treated silica particles obtained in each example are measured by the above-described method.

TABLE 2

| | | | | | | | Characteristics of surface-treated silica particles | | | | | |
|---|---|---|---|---|---|---|---|---|---|---|---|---|
| | | Surface treatment condition | | | | | Average | | | | | Particle |
| Surface- | | Siloxane compound | | | | | circle | | Surface | Compression | Particle | dis- |
| treated | Silica | | Vis- | Addition | | | equivalent | Average | coated | aggregation | com- | persion |
| silica | particle | | cosity | amount | Treatment | Hydrophobizing | diameter | circularity | amount | degree | pression | degree |
| particle | dispersion | Kind | (cSt) | (parts) | atmosphere | agent/parts | (nm) | degree | (wt %) | (%) | ratio | (%) |
| (S1) | (1) | DSO | 10,000 | 0.3 | Supercritical | HMDS/20 parts | 120 | 0.958 | 0.28 | 85 | 0.310 | 98 |
| | | | | | CO₂ | | | | | | | |
| (S2) | (1) | DSO | 10,000 | 1.0 | Supercritical | HMDS/20 parts | 120 | 0.958 | 0.98 | 92 | 0.280 | 97 |
| | | | | | CO₂ | | | | | | | |
| (S3) | (1) | DSO | 5,000 | 0.15 | Supercritical | HMDS/20 parts | 120 | 0.958 | 0.12 | 80 | 0.320 | 99 |
| | | | | | CO₂ | | | | | | | |
| (S4) | (1) | DSO | 5,000 | 0.5 | Supercritical | HMDS/20 parts | 120 | 0.958 | 0.47 | 88 | 0.295 | 98 |
| | | | | | CO₂ | | | | | | | |
| (S5) | (2) | DSO | 10,000 | 0.2 | Supercritical | HMDS/20 parts | 140 | 0.962 | 0.19 | 81 | 0.360 | 99 |
| | | | | | CO₂ | | | | | | | |
| (S6) | (1) | DSO | 10,000 | 1.0 | Atmosphere | HMDS/80 parts | 120 | 0.958 | 0.50 | 83 | 0.380 | 93 |
| (S7) | (3) | DSO | 10,000 | 0.3 | Supercritical | HMDS/20 parts | 130 | 0.850 | 0.29 | 68 | 0.350 | 92 |
| | | | | | CO₂ | | | | | | | |
| (S8) | (4) | DSO | 10,000 | 0.3 | Supercritical | HMDS/20 parts | 90 | 0.935 | 0.29 | 94 | 0.390 | 95 |
| | | | | | CO₂ | | | | | | | |
| (S9) | (1) | DSO | 50,000 | 1.5 | Supercritical | HMDS/20 parts | 120 | 0.958 | 1.25 | 95 | 0.240 | 91 |
| | | | | | CO₂ | | | | | | | |
| (S10) | Fumed | DSO | 10,000 | 0.3 | Supercritical | HMDS/40 parts | 80 | 0.680 | 0.26 | 84 | 0.395 | 92 |
| | silica | | | | CO₂ | | | | | | | |
| | OX50 | | | | | | | | | | | |
| (S11) | Fumed | DSO | 10,000 | 1.0 | Supercritical | HMDS/40 parts | 45 | 0.740 | 0.91 | 88 | 0.396 | 91 |
| | silica A50 | | | | CO₂ | | | | | | | |
| (S12) | (3) | DSO | 5,000 | 0.04 | Supercritical | HMDS/20 parts | 130 | 0.850 | 0.02 | 62 | 0.360 | 96 |
| | | | | | CO₂ | | | | | | | |
| (S13) | (3) | DSO | 1,000 | 0.5 | Supercritical | HMDS/20 parts | 130 | 0.850 | 0.46 | 90 | 0.380 | 92 |
| | | | | | CO₂ | | | | | | | |
| (S14) | (3) | DSO | 10,000 | 5.0 | Supercritical | HMDS/20 parts | 130 | 0.850 | 4.70 | 95 | 0.360 | 91 |
| | | | | | CO₂ | | | | | | | |
| (S15) | (5) | DSO | 10,000 | 0.5 | Supercritical | HMDS/20 parts | 185 | 0.971 | 0.43 | 61 | 0.209 | 96 |
| | | | | | CO₂ | | | | | | | |
| (S16) | (6) | DSO | 10,000 | 0.5 | Supercritical | HMDS/20 parts | 164 | 0.97 | 0.41 | 64 | 0.224 | 97 |
| | | | | | CO₂ | | | | | | | |
| (S17) | (7) | DSO | 10,000 | 0.5 | Supercritical | HMDS/20 parts | 210 | 0.978 | 0.44 | 60 | 0.205 | 98 |
| | | | | | CO₂ | | | | | | | |

TABLE 3

| | | | | | | | Characteristics of surface-treated silica particles | | | | | |
|---|---|---|---|---|---|---|---|---|---|---|---|---|
| | | Surface treatment condition | | | | | Average | | | | | Particle |
| Surface- | | Siloxane compound | | | | | circle | | Surface | Compression | Particle | dis- |
| treated | Silica | | Vis- | Addition | | | equivalent | Average | coated | aggregation | com- | persion |
| silica | particle | | cosity | amount | Treatment | Hydrophobizing | diameter | circularity | amount | degree | pression | degree |
| particle | dispersion | Kind | (cSt) | (parts) | atmosphere | agent/parts | (nm) | degree | (wt %) | (%) | ratio | (%) |
| (SC1) | (1) | — | — | — | Supercritical | HMDS/20 parts | 120 | 0.958 | — | 55 | 0.415 | 99 |
| | | | | | CO₂ | | | | | | | |
| (SC2) | (1) | DSO | 100 | 3.0 | Supercritical | HMDS/20 parts | 120 | 0.958 | 2.5 | 98 | 0.450 | 75 |
| | | | | | CO₂ | | | | | | | |
| (SC3) | (1) | DSO | 1,000 | 8.0 | Supercritical | HMDS/20 parts | 120 | 0.958 | 7.0 | 99 | 0.360 | 83 |
| | | | | | CO₂ | | | | | | | |
| (SC4) | (3) | DSO | 3,000 | 10.0 | Supercritical | HMDS/20 parts | 130 | 0.850 | 8.5 | 99 | 0.380 | 85 |
| | | | | | CO₂ | | | | | | | |
| (SC5) | (1) | — | — | — | Atmosphere | HMDS/80 parts | 120 | 0.958 | — | 62 | 0.425 | 98 |
| (SC6) | (8) | — | — | — | Atmosphere | HMDS/10 parts | 300 | 0.980 | — | 60 | 0.197 | 93 |

Preparation of Resin Particles (A)

23 mol % of dimethyl terephthalate, 10 mol % of isophthalic acid, 15 mol % of dodecenyl succinic anhydride, 3 mol % of trimellitic anhydride, 5 mol % of bisphenol A ethylene oxide 2 mol adduct, and 45 mol % of bisphenol A propylene oxide 2 mol adduct are put into a reaction container equipped with a stirrer, a thermometer, a condenser, and a nitrogen gas inlet pipe, the reaction container is purged with dry nitrogen gas, 0.06 mol % of dibutyl tin oxide, as a catalyst, is added thereto, followed by a stirring reaction at about 190° C. for about 7 hours under a nitrogen gas stream. Then, temperature increases to about 250° C., and then a stirring reaction is further performed for about 5.0 hours. Then, the pressure in the reaction container is reduced to 10.0 mmHg, followed by a stirring reaction for about 0.5 hours under reduced pressure, so as to obtain a polyester resin having a polar group in a molecule thereof.

Next, 100 parts of the polyester resin is molten-kneaded by a Banbury mixer type kneader. The kneaded product is molded in the form of a plate having a thickness of 1 cm by rolling roll, coarsely pulverized to several millimeters by a Fitz mill type pulverizer, finely pulverized by an IDS type pulverized, and then sequentially classified by an elbow type classifier, so as to obtain resin particles (A) having an volume average particle diameter of 7 μm.

Preparation of Resin Particles (B) and (C)

In the preparation of the resin particles (A), classifications are sequentially performed by the elbow type classifier, so as to obtain resin particles (B) having an volume average particle diameter of 1μm and resin particles (C) having an volume average particle diameter of 15 μm.

Preparation of Resin Particles (D)

Preparation of Resin Particle Dispersion

A solution, in which 285 parts of styrene, 115 parts of n-butyl acrylate, 8 parts of acrylic acid, 24 parts of dodecanethiol are mixed and dissolved, is emulsified in a flask in which 6 parts of a nonionic surfactant (NONIPOL 400: manufactured by Sanyo Chemical Industries Co., Ltd.) and 10 parts of an anionic surfactant (NEOGEN SC: manufactured by DKS Co., Ltd.) are dissolved in 550 parts of ion-exchanged water, and 50 parts of ion-exchanged water in which 4 parts of ammonium persulfate is dissolved is put into the flask while mixing slowly for 10 minutes. After purging with nitrogen, the resultant is heated to 70° C. in an oil bath while stirring in the flask, and the emulsion polymerization continues for 5 hours. As a result, a resin particle dispersion, in which resin particles having an average particle diameter of 150 nm, a glass transition temperature (Tg) of 53° C., a weight average molecular weight (Mw) of 32,000 are dispersed, is obtained. The solid concentration of this dispersion is 40%.

Preparation of Release Agent Dispersion

Carnauba wax (manufactured by TOAKASEI Co., Ltd.) 5 parts: 45 parts

Cationic surfactant NEOGEN RK (manufactured by DKS Co., Ltd.): 5 parts

Ion-exchanged water: 200 parts

The above components are heated to 120° C. and dispersed by ULTRATURRAX T50 manufactured by IKA Co., Ltd., and then dispersion treatment is performed by a pressure discharge type Gaulin homogenizer, so as to obtain a release agent dispersion containing release agent particles having a median particle diameter of 196 nm and having a solid content of 22.0%.

Preparation of Release Agent-containing Resin Particles

Resin particle dispersion: 320 parts

Release agent dispersion: 16 parts

Poly aluminum hydroxide (PAHO 2S, manufactured by Asada Chemical Industry Co., Ltd.): 0.5 parts

Ion-exchanged water: 600 parts

The above components are mixed and dispersed by using a homogenizer (ULTRATURRAX T50: IKA Co., Ltd.) in a round stainless steel flask, and then heated to 40° C. while stirring in the flask in a heating oil bath. After keeping at 40° C. for 30 minutes, it is confirmed that aggregate particles having an average particle diameter (D50) of 4.5 μm are formed. Further, after increasing the temperature of the heating oil bath to 56° C. and keeping at 56° C. for 1.5 hours, D50 is set to 6.8 μm.

1N sodium hydroxide was added to the dispersion containing these aggregate particles to adjust the pH of the system to 5.0. Then, the stainless steel flask is sealed, heated to 95° C. while stirring with a magnetic seal, and kept for 4 hours. After cooling, resin particles are filtered, washed with ion-exchanged water four times, and then freeze-dried, so as to obtain resin particles (D) having an volume average particle diameter of 6.3 μm.

The content of a release agent in the resin particles (D) is 5% by weight.

Further, the exposure rate of the release agent of the resin particles (D) is 8% by atom, and the average circularity degree thereof is 0.95.

Providing of Lubricant Particles

Lubricant particles are provided as follows.

Lubricant particles (a): zinc stearate particles (NISSAN ELECTOR (registered trademark) MZ-2, average circle-equivalent diameter by volume: 1.5 μm, manufactured by NOF CORPORATION)

Lubricant particles (b): boron nitride particles (FS-1, average circle-equivalent diameter by volume: 0.5 mm, manufactured by MIZUSHIMA FERROALLOY CO., LTD.)

Lubricant particles (c): polytetrafluoroethylene particles (LIBRON (registered trademark) L-2, average circle-equivalent diameter by volume: 3.5 manufactured by DAIKIN INDUSTRIES, LTD.)

### EXAMPLES 1 TO 25 AND COMPARATIVE EXAMPLE 1 TO 7

According to Tables 4 and 5, surface-treated silica particles and lubricant particles are combined with 20 parts of the resin particles (A), and mixed by a 0.4 L sample mill at 15,000 rpm for 30 seconds, so as to obtain a resin particle composition of Example 1.

Evaluation of Resin Particle Composition

With respect to each of the resin particle compositions obtained in Examples 1 to 25 and Comparative Example 1 to 7, the treatability of the resin particle composition, the fluidity of resin particles, and the amount of the resin particle composition fixed into a pipe at the time of transporting the resin particle composition are evaluated by the following method.

The results thereof are summarized in Tables 4 and 5.

Evaluation of Treatability Of Resin Particle Composition

As an index of the treatability of the resin particle composition, the high-temperature environmental treatability of the resin particle composition in each Example is evaluated. Specifically, after the resin particle composition is left for 17 hours under high temperature and low humidity environments (under environments of a temperature of 30° C. and a relative humidity (RH) of 20%), the resin particle composition is mixed by shaking the particle resin composition for 25 minutes using a shaker, placed on a 75 μm sieve, and vibrated at an amplitude of 1 mm for 90 seconds. Then, the shape of fall of resin particles in the resin particle composition is observed, and the treatability of the resin particle composition is evaluated based on the following criteria.

Evaluation criteria

A: resin particles do not remain on the sieve.

B: a few of resin particles remain on the sieve.

C: a lot of resin particles remain on the sieve.

Evaluation of fluidity of resin particle composition

The compressed apparent specific gravity and loose apparent specific gravity of the resin particle composition having been used in the evaluation of treatability of the resin particle composition are measured by a powder tester manufactured by Hosokawa Micron Corporation. Then, the particle compression ratio is calculated from the ratio of compressed apparent specific gravity and loose apparent specific gravity, using Equation below.

Equation: particle compression ratio =(compressed apparent specific gravity-loose apparent specific gravity)/compressed apparent specific gravity

Here, the “loose apparent specific gravity” is a measurement value derived by filling a sample cup having a volume of 100 cm³ with the resin particle composition and weighing the sample cup filled with the resin particle composition, and refers to filling specific gravity in a state of the resin particle composition being naturally fallen into the sample cup. The “compressed apparent specific gravity” refers to apparent specific gravity of the resin particle composition particles which are deaerated, rearranged and more densely packed by tapping from the state of loose apparent specific gravity. Even in the evaluation of fluidity, similarly to the evaluation of dispersion holding properties, mechanical load is given by performing the mixing for 60 minutes with a turbula shaker. The fluidity of the resin particle composition is evaluated based on the following criteria.

Evaluation criteria

A: compression ratio is less than 0.2

B: compression ratio is 0.2 or more and less than 0.3

C: compression ratio is 0.3 or more and less than 0.4

D: compression ratio is 0.4 or more

Evaluation of adhesion amount (attached amount) of resin particle composition into a pipe at the time of transporting the resin particle composition by using air

A test pipe having an inner diameter φ of 47.8 mm, the inner side of which is coated with a room temperature curable silicone resin (SR2411, manufactured by Toray Dow Corning Silicone Co., Ltd.), is provided. The test requiring an elbow portion to be bended at a right angle of 90 is provided with a filter at a suction tip in a blower to set linear speed to 5.0 m/min, and the suction test of the resin particle composition was performed. Thereafter, resin particles are transported by using air such that the solid-gas ratio is 0.5, and the rate of the amount of the resin particles attached to the pipe after 3 minutes to the total amount of the resin particles is evaluated based on the following criteria.

Evaluation criteria

A: the amount attached to the pipe is less than 1%.

B: the amount attached to the pipe is 1% or more and less than 5%.

C: the amount attached to the pipe is 5% or more.

TABLE 4

| | Surface-treated | | | | | | | |
|---|---|---|---|---|---|---|---|---|
| | silica particle | | Lubricant particle | | | | | |
| | | Content to resin | | Content to resin | | Evaluation | | |
| | | particle | | particle | Resin particle | | | Amount attached |
| | No. | (wt %) | No. | (wt %) | No. | Treatability | Fluidity | to the pipe |
| Example 1 | S1 | 2.0 | a | 3.0 | A | A | A | A |
| Example 2 | S2 | 2.0 | a | 3.0 | A | A | A | A |
| Example 3 | S3 | 2.0 | a | 3.0 | A | A | A | A |
| Example 4 | S4 | 2.0 | a | 3.0 | A | A | A | A |
| Example 5 | S5 | 2.0 | a | 3.0 | A | A | A | A |
| Example 6 | S6 | 2.0 | a | 3.0 | A | B | A | B |
| Example 7 | S7 | 2.0 | a | 3.0 | A | A | A | B |
| Example 8 | S8 | 2.0 | a | 3.0 | A | B | A | B |
| Example 9 | S9 | 2.0 | a | 3.0 | A | A | A | B |
| Example 10 | S10 | 2.0 | a | 3.0 | A | B | A | B |
| Example 11 | S11 | 2.0 | a | 3.0 | A | B | A | B |
| Example 12 | S12 | 2.0 | a | 3.0 | A | A | A | B |
| Example 13 | S13 | 2.0 | a | 3.0 | A | B | A | B |
| Example 14 | S14 | 2.0 | a | 3.0 | A | A | A | A |
| Example 15 | S15 | 2.0 | a | 3.0 | A | B | B | B |
| Example 16 | S16 | 2.0 | a | 3.0 | A | B | B | B |
| Example 17 | S17 | 2.0 | a | 3.0 | A | B | B | B |
| Example 18 | S1 | 2.0 | a | 3.0 | B | B | A | B |
| Example 19 | S1 | 2.0 | a | 3.0 | C | A | A | B |
| Example 20 | S1 | 2.0 | a | 3.0 | D | B | B | B |
| Example 21 | S1 | 2.0 | b | 3.0 | A | A | A | B |
| Example 22 | S1 | 2.0 | c | 3.0 | A | A | A | B |
| Example 23 | S1 | 10.0 | a | 8.0 | A | A | A | B |
| Example 24 | S1 | 2.0 | a | 0.1 | A | A | A | B |
| Example 25 | S1 | 2.0 | a | 15.0 | A | B | A | B |

TABLE 5

| | Surface-treated | | | | | | | |
|---|---|---|---|---|---|---|---|---|
| | silica particle | | Lubricant particle | | | | | |
| | | Content to resin | | Content to resin | | Evaluation | | |
| | | particle | | particle | Resin particle | | | Amount attached |
| | No. | (wt %) | No. | (wt %) | No. | Treatability | Fluidity | to the pipe |
| Comparative | SC1 | 2.0 | a | 3.0 | A | C | C | C |
| Example 1 | | | | | | | | |
| Comparative | SC2 | 2.0 | a | 3.0 | A | B | D | C |
| Example 2 | | | | | | | | |
| Comparative | SC3 | 2.0 | a | 3.0 | A | C | C | C |
| Example 3 | | | | | | | | |
| Comparative | SC4 | 2.0 | a | 3.0 | A | C | C | C |
| Example 4 | | | | | | | | |
| Comparative | SC5 | 2.0 | a | 3.0 | A | C | C | C |
| Example 5 | | | | | | | | |
| Comparative | SC6 | 2.0 | a | 3.0 | A | A | C | C |
| Example 6 | | | | | | | | |

| | | | | | | | |
|---|---|---|---|---|---|---|---|
| Comparative | S1 | 2.0 | Not added | A | C | B | C |
| Example 7 | | | | | | | |

From the above results, it is found that Examples are excellent in fluidity of resin particles, treatability of resin particle composition, and adhesion amount (attached amount) of resin particle composition into a pipe at the time of transporting the resin particle composition by using air, compared to Comparative Examples.

(preparation Of Release Agent-containing Resin Particles (a))

23 mol % of dimethyl terephthalate, 10 mol % of isophthalic acid, 15 mol % of dodecenyl succinic anhydride, 3 mol % of trimellitic anhydride, 5 mol % of bisphenol A ethylene oxide 2 mol adduct, and 45 mol % of bisphenol A propylene oxide 2 mol adduct are put into a reaction container equipped with a stirrer, a thermometer, a condenser, and a nitrogen gas inlet pipe, the reaction container is purged with dry nitrogen gas, 0.06 mol % of dibutyl tin oxide, as a catalyst, is added thereto, followed by a stirring reaction at about 190° C. for about 7 hours under a nitrogen gas stream. Then, temperature increases to about 250° C., and then a stirring reaction is further performed for about 5.0 hours. Then, the pressure in the reaction container is reduced to 10.0 mmHg, followed by a stirring reaction for about 0.5 hours under reduced pressure, so as to obtain a polyester resin having a polar group in a molecule thereof.

Next, 95 parts of the polyester resin and 5 parts of carnauba wax (manufactured by TOAKASEI Co., Ltd.) are molten-kneaded by a Banbury mixer type kneader. The kneaded product is molded in the form of a plate having a thickness (slab thickness) of about 1 cm by rolling roll, coarsely pulverized to several millimeters by a Fitz mill type pulverizer, finely pulverized by an IDS type pulverized, and then sequentially classified by an elbow type classifier, so as to obtain release agent-containing resin particles (A) having an volume average particle diameter of 7 μm.

In the release agent-containing resin particles (A), the content of the release agent is 5% by weight.

The exposure rate of the release agent of the release agent-containing resin particles (A) is 8% by atom, and the average circularity degree thereof is 0.93.

Preparation of Release Agent-containing Resin Particles (B) and (C)

In the preparation of the release agent-containing resin particles (A), classifications are sequentially performed by the elbow type classifier, so as to obtain release agent-containing resin particles (B) having an volume average particle diameter of 1 μm and release agent-containing resin particles (C) having an volume average particle diameter of 15 μm.

Even in any of the release agent-containing resin particles (B) and (C), the content of the release agent is 5% by weight.

The exposure rate of the release agent of the release agent-containing resin particles (B) is 11% by atom, and the average circularity degree thereof is 0.94.

The exposure rate of the release agent of the release agent-containing resin particles (C) is 6% by atom, and the average circularity degree thereof is 0.93.

Preparation of Release Agent-containing Resin Particles (D)

Release agent-containing resin particles (D) having an volume average particle diameter of 8 μm are obtained by performing the melt-kneading in the same manner as the agent-containing resin particles (A), except that 5 parts of paraffin wax (manufactured by NIPPON SEIRO CO., LTD.) is used as wax.

In the release agent-containing resin particles (D), the content of the release agent is 5% by weight.

The exposure rate of the release agent of the release agent-containing resin particles (D) is 5% by atom, and the average circularity degree thereof is 0.94.

Preparation of Release Agent-containing Resin Particles (E)

Preparation of Resin Particle Dispersion

A solution, in which 285 parts of styrene, 115 parts of n-butyl acrylate, 8 parts of acrylic acid, 24 parts of dodecanethiol are mixed and dissolved, is emulsified in a flask in which 6 parts of a nonionic surfactant (NONIPOL 400: manufactured by Sanyo Chemical Industries Co., Ltd.) and 10 parts of an anionic surfactant (NEOGEN SC: manufactured by DKS Co., Ltd.) are dissolved in 550 parts of ion-exchanged water, and 50 parts of ion-exchanged water in which 4 parts of ammonium persulfate is dissolved is put into the flask while mixing slowly for 10 minutes. After purging with nitrogen, the resultant is heated to 70° C. in an oil bath while stirring in the flask, and the emulsion polymerization continues for 5 hours. As a result, a resin particle dispersion, in which resin particles having an average particle diameter of 150 nm, a glass transition temperature (Tg) of 53° C., a weight average molecular weight (Mw) of 32,000 are dispersed, is obtained. The solid concentration of the dispersion is 40%.

Preparation of Release Agent Dispersion

Carnauba wax (manufactured by TOAKASEI Co., Ltd.) 5 parts: 45 parts

Cationic surfactant NEOGEN RK (manufactured by DKS Co., Ltd.): 5 parts

Ion-exchanged water: 200 parts

The above components are heated to 120° C. and dispersed by ULTRATURRAX T50 manufactured by IKA Co., Ltd., and then dispersion treatment is performed by a pressure discharge type Gaulin homogenizer, so as to obtain a release agent dispersion containing release agent particles having a median particle diameter of 196 nm and having a solid content of 22.0%.

Preparation of Release Agent-containing Resin Particles

Resin particle dispersion: 320 parts

Release agent dispersion: 16 parts

Poly aluminum hydroxide (PAHO 2S, manufactured by Asada Chemical Industry Co., Ltd.): 0.5 parts

Ion-exchanged water: 600 parts

The above components are mixed and dispersed by using a homogenizer (ULTRATURRAX T50: IKA Co., Ltd.) in a round stainless steel flask, and then heated to 40° C. while stirring in the flask in a heating oil bath. After keeping at 40° C. for 30 minutes, it is confirmed that aggregate particles having an average particle diameter (D50) of 4.5 μm are formed. Further, after increasing the temperature of the heating oil bath to 56° C. and keeping at 56° C. for 1.5 hours, D50 is set to 6.8 μm.

IN sodium hydroxide was added to the dispersion containing these aggregate particles to adjust the pH of the system to 5.0. Then, the stainless steel flask is sealed, heated to 95° C. while stirring with a magnetic seal, and kept for 4 hours. After cooling, resin particles are filtered, washed with ion-exchanged water four times, and then freeze-dried, so as to obtain resin particles (E) having an volume average particle diameter of 6.3

The content of a release agent in the resin particles (E) is 5% by weight.

Further, the exposure rate of the release agent of the resin particles (E) is 8% by atom, and the average circularity degree thereof is 0.95.

Preparation of Resin Particles not Containing Release Agent (F)

Resin particles not containing release agent (F) having an volume average particle diameter of 7 μm are obtained in the same manner as the preparation of the agent-containing resin particles (A), except that carnauba wax is not used, and 100 parts of a polyester resin is used.

Preparation of Release Agent-containing Resin Particles (G)

Release agent-containing resin particles (G) having an volume average particle diameter of 7 μm are obtained in the same manner as the preparation of the agent-containing resin particles (A), except that 98 parts of a polyester resin and 2 parts of carnauba wax (manufactured by TOAKASEI CO., LTD.) are used. In the release agent-containing resin particles (G), the content of the release agent is 2% by weight.

The exposure rate of the release agent of the release agent-containing resin particles (G) is 5% by atom, and the average circularity degree thereof is 0.92.

Preparation of Release Agent-containing Resin Particles (H)

Release agent-containing resin particles (H) having an volume average particle diameter of 7 μm are obtained in the same manner as the preparation of the agent-containing resin particles (A), except that 83 parts of a polyester resin and 17 parts of carnauba wax (manufactured by TOAKASEI CO., LTD.) are used. In the release agent-containing resin particles (H), the content of the release agent is 17% by weight.

The exposure rate of the release agent of the release agent-containing resin particles (H) is 36% by atom, and the average circularity degree thereof is 0.91.

Preparation of Release Agent-containing Resin Particles (I)

Release agent-containing resin particles (I) having an volume average particle diameter of 7 μm are obtained in the same manner as the preparation of the agent-containing resin particles (A), except that 75 parts of a polyester resin and 25 parts of carnauba wax (manufactured by TOAKASEI CO., LTD.) are used.

In the release agent-containing resin particles (I), the content of the release agent is 25% by weight.

The exposure rate of the release agent of the release agent-containing resin particles (I) is 45% by atom, and the average circularity degree thereof is 0.91.

### EXAMPLES 1 TO 26 AND COMPARATIVE EXAMPLE 1 TO 7

According to Tables 6 and 7, surface-treated silica particles are combined with 20 parts of the resin particles, and mixed by a 0.4 L sample mill at 15,000 rpm for 30 seconds, so as to obtain resin particle compositions of Examples 1 to 26 and Comparative Example 1 to 7.

Evaluation of Resin Particle Composition

With respect to each of the resin particle compositions obtained in Examples 1 to 26 and Comparative Example 1 to 7, the treatability of the resin particle composition, the fluidity of resin particles, and the amount of the resin particle composition fixed into a pipe at the time of transporting the resin particle composition are evaluated by the following method.

The results thereof are summarized in Tables 6 and 7.

Evaluation of Treatability of Resin Particle Composition

As an index of the treatability of the resin particle composition, the high-temperature environmental treatability of the resin particle composition in each Example is evaluated. Specifically, after the resin particle composition was left for 17 hours under high temperature and low humidity environments (under environments of a temperature of 30° C. and a relative humidity (RH) of 85%), the resin particle composition was mixed by shaking the particle resin composition for 25 minutes using a shaker, placed on a 75 μm sieve, and vibrated at an amplitude of 1 mm for 90 seconds. Then, the shape of fall of resin particles in the resin particle composition is observed, and the treatability of the resin particle composition is evaluated based on the following criteria.

Evaluation Criteria

A: resin particles do not remain on the sieve.

B: a few of resin particles remain on the sieve.

C: a lot of resin particles remain on the sieve.

Evaluation of Fluidity of Resin Particle Composition

The compressed apparent specific gravity and loose apparent specific gravity of the resin particle composition having been used in the evaluation of treatability of the resin particle composition are measured by a powder tester manufactured by Hosokawa Micron Corporation. Then, the particle compression ratio is calculated from the ratio of compressed apparent specific gravity and loose apparent specific gravity, using Equation below.

particle compression ratio=(compressed apparent specific gravity−loose apparent specific gravity)/compressed apparent specific gravity Equation:

Here, the “loose apparent specific gravity” is a measurement value derived by filling a sample cup having a volume of 100 cm³ with the resin particle composition and weighing the sample cup filled with the resin particle composition, and refers to filling specific gravity in a state of the resin particle composition being naturally fallen into the sample cup. The “compressed apparent specific gravity” refers to apparent specific gravity of the resin particle composition particles which are deaerated, rearranged and more densely packed by tapping from the state of loose apparent specific gravity. Even in the evaluation of fluidity, similarly to the evaluation of dispersion holding properties, mechanical load is given by performing the mixing for 60 minutes with a turbula shaker. The fluidity of the resin particle composition is evaluated based on the following criteria.

Evaluation Criteria

A: compression ratio is less than 0.2

B: compression ratio is 0.2 or more and less than 0.3

C: compression ratio is 0.3 or more and less than 0.4

D: compression ratio is 0.4 or more

Evaluation of adhesion amount (attached amount) of resin particle composition into a pipe at the time of transporting the resin particle composition by using air

A test pipe having an inner diameter φ of 47.8 mm is provided. The test requiring an elbow portion to be bended at a right angle of 90 is provided with a filter at a suction tip in a blower to set linear speed to 5.0 m/min, and the suction test of the resin particle composition was performed. Thereafter, resin particles are transported by using air such that the solid-gas ratio is 0.5, and the rate of the amount of the resin particles attached to the pipe after 3 minutes to the total amount of the resin particles is evaluated based on the following criteria.

Evaluation Criteria

A: the amount attached to the pipe is less than 3%.

B: the amount attached to the pipe is 3% or more and less than 10%.

C: the amount attached to the pipe is 10% or more.

TABLE 6

| | Surface-treated | | | | | | | | |
|---|---|---|---|---|---|---|---|---|---|
| | silica particle | | Resin particle | | | | | | |
| | | Content to resin | | Content of | Exposure rate of | Average | Evaluation | | |
| | | particle | | release agent | release agent | circularity | | | Amount attached |
| | No. | (wt %) | No. | (wt %) | (atom %) | degree | Treatability | Fluidity | to the pipe |
| Example 1 | S1 | 2.0 | A | 5 | 8 | 0.93 | A | A | A |
| Example 2 | S2 | 2.0 | A | 5 | 8 | 0.93 | A | A | A |
| Example 3 | S3 | 2.0 | A | 5 | 8 | 0.93 | A | A | A |
| Example 4 | S4 | 2.0 | A | 5 | 8 | 0.93 | A | A | A |
| Example 5 | S5 | 2.0 | A | 5 | 8 | 0.93 | A | A | A |
| Example 6 | S6 | 2.0 | A | 5 | 8 | 0.93 | B | B | B |
| Example 7 | S7 | 2.0 | A | 5 | 8 | 0.93 | B | A | A |
| Example 8 | S8 | 2.0 | A | 5 | 8 | 0.93 | B | B | A |
| Example 9 | S9 | 2.0 | A | 5 | 8 | 0.93 | B | A | A |
| Example 10 | S10 | 2.0 | A | 5 | 8 | 0.93 | B | B | B |
| Example 11 | S11 | 2.0 | A | 5 | 8 | 0.93 | B | B | B |
| Example 12 | S12 | 2.0 | A | 5 | 8 | 0.93 | B | A | A |
| Example 13 | S13 | 2.0 | A | 5 | 8 | 0.93 | B | B | A |
| Example 14 | S14 | 2.0 | A | 5 | 8 | 0.93 | A | A | A |
| Example 15 | S15 | 2.0 | A | 5 | 8 | 0.93 | B | B | B |
| Example 16 | S16 | 2.0 | A | 5 | 8 | 0.93 | B | B | B |
| Example 17 | S17 | 2.0 | A | 5 | 8 | 0.93 | B | B | B |
| Example 18 | S1 | 4.0 | B | 5 | 11 | 0.94 | B | B | B |
| Example 19 | S1 | 2.0 | C | 5 | 6 | 0.93 | B | A | A |
| Example 20 | S1 | 2.0 | D | 5 | 5 | 0.94 | B | A | A |
| Example 21 | S1 | 2.0 | E | 5 | 8 | 0.95 | B | A | A |
| Example 22 | S1 | 2.0 | G | 2 | 5 | 0.92 | B | A | A |
| Example 23 | S2 | 1.0 | H | 17 | 36 | 0.91 | B | B | B |
| Example 24 | S1 | 2.0 | I | 25 | 45 | 0.91 | C | C | B |
| Example 25 | S1 | 4.0 | A | 5 | 8 | 0.93 | A | A | A |
| Example 26 | S1 | 10.0 | A | 5 | 8 | 0.93 | A | A | A |

TABLE 7

| | Surface-treated | | | | | | | | |
|---|---|---|---|---|---|---|---|---|---|
| | silica particle | | Resin particle | | | | | | |
| | | Content to resin | | Content of | Exposure rate of | Average | Evaluation | | |
| | | particle | | release agent | release agent | circularity | | | Amount attached |
| | No. | (wt %) | No. | (wt %) | (atom %) | degree | Treatability | Fluidity | to the pipe |
| Comparative | SC1 | 2.0 | A | 5 | 8 | 0.93 | C | D | C |
| Example 1 | | | | | | | | | |
| Comparative | SC2 | 2.0 | A | 5 | 8 | 0.93 | B | D | C |
| Example 2 | | | | | | | | | |
| Comparative | SC3 | 2.0 | A | 5 | 8 | 0.93 | C | C | C |
| Example 3 | | | | | | | | | |
| Comparative | SC4 | 2.0 | A | 5 | 8 | 0.93 | C | C | C |
| Example 4 | | | | | | | | | |
| Comparative | SC5 | 2.0 | A | 5 | 8 | 0.93 | C | C | C |
| Example 5 | | | | | | | | | |
| Comparative | SC6 | 2.0 | A | 5 | 8 | 0.93 | A | C | C |
| Example 6 | | | | | | | | | |
| Comparative | S1 | 2.0 | F | Not added | — | — | A | A | C |
| Example 7 | | | | | | | | | |

From the above results, it is found that Examples are excellent in fluidity of resin particles, treatability of resin particle composition, and adhesion amount (attached amount) of resin particle composition into a pipe at the time of transporting the resin particle composition by using air, compared to Comparative Examples.

What is claimed is:

1. A resin particle composition, comprising:
resin particles;
lubricant particles; and
silica particles having a compression aggregation degree of 60% to 95% and a particle compression ratio of 0.20 to 0.40.

2. The resin particle composition according to claim 1,
wherein a content of the lubricant particles with respect to the resin particles is 0.1% by weight to 8% by weight.

3. The resin particle composition according to claim 1,
wherein an average circle-equivalent diameter of the lubricant particles by volume is 0.1 μm to 10.0 μm.

4. The resin particle composition according to claim 1,
wherein a content of the lubricant particles with respect to the resin particles is 1% by weight or more.

5. The resin particle composition according to claim 1,
wherein the lubricant particles are fatty acid metal salt particles.

6. The resin particle composition according to claim 5,
wherein the fatty acid metal salt particles are zinc stearate.

7. The resin particle composition according to claim 1,
wherein an average circle-equivalent diameter of the silica particles is 40 nm to 200 nm.

8. The resin particle composition according to claim 1,
wherein a particle dispersion degree of the silica particles is 90% to 100%.

9. The resin particle composition according to claim 1,
wherein the silica particles contain a siloxane compound having a viscosity of 1,000 cSt to 50,000 cSt, and a surface coated amount of the siloxane compound is 0.01% by weight to 5% by weight.

10. The resin particle composition according to claim 9,
wherein the siloxane compound is silicone oil.

11. The resin particle composition according to claim 1,
wherein an average circularity degree of the silica particles is 0.85 to 0.98.

12. The resin particle composition according to claim 1,
wherein a content of the silica particles with respect to the resin particles is 0.05% by weight to 7.0% by weight.

13. A resin particle composition, comprising:
resin particles, on the surface of which at least a part of a release agent is exposed; and
silica particles having a compression aggregation degree of 60% to 95% and a particle compression ratio of 0.20 to 0.40.

14. The resin particle composition according to claim 13,
wherein a content of the release agent in the resin particles, on the surface of which at least a part of the release agent is exposed, is 1% by weight to 20% by weight.

15. The resin particle composition according to claim 13,
wherein an average circle-equivalent diameter of the silica particles is 40 nm to 200 nm.

16. The resin particle composition according to claim 13,
wherein a particle dispersion degree of the silica particles is 90% to 100%.

17. The resin particle composition according to claim 13,
wherein the silica particles contain a siloxane compound having a viscosity of 1,000 cSt to 50,000 cSt, and a surface coated amount of the siloxane compound is 0.01% by weight to 5% by weight.

18. The resin particle composition according to claim 17,
wherein the siloxane compound is silicone oil.
